(19) United States
(12) Patent Application Publication
(10) Pub. No.: US 2024/0174774 A1
(43) Pub. Date: May 30, 2024

(54) PROCESS FOR PRODUCING HETEROPHASIC PROPYLENE RESIN

(71) Applicant: BOREALIS AG, Vienna (AT)

(72) Inventors: Wilfried Peter TÖLTSCH, Linz (AT); Luigi Maria Cristoforo RESCONI, Linz (AT)

(21) Appl. No.: 18/283,952

(22) PCT Filed: Mar. 24, 2022
(86) PCT No.: PCT/EP2022/057846

§ 371 Date: Sep. 25, 2023

(30) Foreign Application Priority Data
Mar. 24, 2021 (EP) 21164551.0

(51) Int. Cl. C08F 10/06; C08F 4/02; C08F 4/6592

(52) U.S. Cl. CPC C08F 10/06; C08F 4/02; C08F 4/65927; C08F 2420/07

(57) ABSTRACT

The invention relates to a process for the preparation of a heterophasic polypropylene resin in a multistage polymerisation process in the presence of a metallocene catalyst, said process comprising: (I) in a first polymerisation step, polymerising propylene and optionally at least one C2-10 alpha olefin comonomer; and subsequently (II) in a second polymerisation step, polymerising propylene, ethylene and optionally at least one C3-10 alpha olefin comonomer, in the presence of the metallocene catalyst and polymer from step (I); wherein step (II) takes place in at least one gas phase reactor operating at a pressure of at least 26 bar. The present invention further relates to a heterophasic polypropylene resin comprising a polypropylene matrix phase (A) and an ethylene-propylene copolymer phase (B) dispersed within said polypropylene matrix phase, wherein the ethylene-propylene copolymer phase (B) is an amorphous ethylene-propylene copolymer with an intrinsic viscosity (iV) measured in decalin at 135° C. of at least 3.5 dl/g and an ethylene content of at least 15 wt % of the total weight to the ethylene-propylene copolymer, comprising at least 4 long chain branches (LCB) per copolymer chain.

### FIELD OF THE DISCLOSURE

The present invention relates to a process for producing a heterophasic propylene resin using a metallocene catalyst in a multistage polymerisation process. In particular, the invention relates to a process wherein the chemical and physical properties of the rubber phase of the heterophasic propylene resin can be controlled. This is achieved through the use of a gas phase reactor, operating at a particular pressure, to produce said rubber phase. The present invention further relates to a heterophasic propylene resin comprising an amorphous ethylene propylene copolymer with unique properties and articles comprising said resins.

### BACKGROUND OF THE DISCLOSURE

Multistage polymerisation processes are well known and widely used in the art for producing polypropylene compositions. Process configurations containing at least one slurry phase polymerisation reactor and at least one gas phase polymerisation reactor are disclosed e.g. in U.S. Pat. No. 4,740,550, and further e.g. in WO98/058975 and WO98/058976. A prepolymerisation reactor is often included in the process configuration, typically to maximise catalyst performance.

Single site catalysts have been used to manufacture polyolefins for many years. Countless academic and patent publications describe the use of these catalysts in olefin polymerisation. One big group of single site catalysts are metallocenes, which are nowadays used industrially and polyethylenes and polypropylenes in particular are often produced using cyclopentadienyl based catalyst systems with different substitution patterns.

Single site catalysts such as metallocenes are used in propylene polymerisation in order to achieve some desired polymer properties. However, there are some limitations in using metallocenes on an industrial scale in multistage polymerisation configurations, especially when producing copolymers in gas phase. Thus, there is room for improving the process and catalyst behaviour in the process.

As discussed, the multistage polymerisation of propylene often takes place using at least one slurry phase polymerisation reactor and at least one gas phase polymerisation reactor. In the context of a heterophasic polypropylene resin, which comprises a propylene homopolymer matrix (or a propylene copolymer matrix with a low comonomer content, i.e. a random propylene copolymer) and a propylene ethylene (or propylene-ethylene-alpha-olefin terpolymer) rubber component which is typically dispersed within the matrix, the rubber component is usually produced in one or more gas phase reactor (GPR). Examples of such processes are disclosed in WO2018/122134 and WO2019/179959. However, metallocene catalysts have several limitations when used to produce ethylene-propylene copolymers (EPR) in the gas phase.

One of these limitations is a relatively low ethylene reactivity relative to propylene (the so-called C2/C3 reactivity ratio) in the gas phase, which is typically below 0.5. This means that the C2/C3 gas phase ratio fed to the reactor must be significantly higher than the desired copolymer composition. However, the C2/C3 gas phase ratio feed to the GPR is limited to low values due to pressure limitations in the GPR. For this reason, under commonly used temperature and pressure conditions, the rubber C2 content is limited upwards when using metallocene catalysts.

A second limitation is the generally low molecular weight of the rubber produced in gas phase with metallocene catalysts, and the higher is the ethylene content in the copolymer (up to 50 to 60 wt %), the lower becomes the molecular weight of the rubber. In other words, most metallocene catalysts have a lower molecular weight capability in gas phase copolymerisation compared to their molecular weight capability for homo- or copolymerisation in condensed phase. A low intrinsic viscosity (IV) value of the rubber phase reflects a low molecular weight.

WO2015/139875 discloses a process for the preparation of a heterophasic propylene copolymer (RAHECO) comprising (i) a matrix (M) being a propylene copolymer (R-PP) and (ii) an elastomeric propylene copolymer (EC) dispersed in said matrix (M). The rubber phase dispersed in the heterophasic propylene copolymer obtained by the disclosed process has low molecular weight reflected by intrinsic viscosity of equal or below 2.2 dl/g.

WO2011/050963 discloses a process for the preparation of a heterophasic polypropylene resin, comprising a propylene random copolymer matrix phase (A), and an ethylene-propylene copolymer rubber phase (B) dispersed within the matrix phase. The rubber phase disperser in the heterophasic copolymer obtained by the disclosed process has low molecular weight reflected by intrinsic viscosity of 1.0 to 2.5 dl/g, while being modified to have long chain branching reflected by having a strain hardening factor (SHF) of 0.7 to 4.0 when measured at a strain rate of 3.0 s″ and a Hencky strain of 3.0.

In addition, the chemical nature of amorphous ethylene-propylene rubbers (linear, meaning without long chain branches) limits their application range, especially when elastic recovery (good tension set and compression set), high shock absorption (impact strength), and shape stability (low flow under compression or stretching) are required.

These properties can be improved by a combination of very high molecular weight and the presence of long chain branches.

WO2019/134951 discloses a process for the preparation of a heterophasic propylene polymer (HECO) comprising a) a matrix component (M) selected from a propylene homo- or random copolymer (PP); and b) an ethylene-propylene rubber (EPR), dispersed in the propylene homo- or random copolymer (PP), whereby the xylene cold soluble fraction (XCS) of the heterophasic propylene polymer (HECO) has an intrinsic viscosity (IV), within the range of 1.1 to 3.4 dl/g; and the xylene cold insoluble fraction (XCI) of the heterophasic propylene polymer (HECO) has 2,1-erythro regiodefects in an amount of at least 0.4 mol % to a composition comprising the heterophasic propylene polymer (HECO).The present inventors have now found a particular set of operating conditions for the gas phase reactor, which are able to solve the problems disclosed above. In particular, the invention combines the use of a particular class of metallocene catalysts with a gas phase reactor operating at increased pressure. Surprisingly, this combination allows for both an improved catalyst performance (such as a higher C2/C3 reactivity ratio and a higher molecular weight capability) and improved rubber properties, provided by its higher molecular weight and increased content of long chain branching. This has led to the identification of ethylene-propylene rubbers with unique properties. In a defined set of polymerisation conditions, the catalysts of the present invention can produce rubbers in a molecular weight range not previously obtainable and containing long chain branches.

### BRIEF DESCRIPTION OF THE DISCLOSURE

The invention provides a process for the preparation of a heterophasic polypropylene resin, in a multistage polymerisation process in the presence of a metallocene catalyst, said process comprising:
(I) in a first polymerisation step, performed in one or more reactors, polymerising propylene and optionally at least one C2-10 alpha olefin comonomer; and subsequently
(II) in a second polymerisation step, polymerising propylene, ethylene and optionally at least one C4-10 alpha olefin comonomer, in the presence of the metallocene catalyst and polymer from step (I);
wherein said metallocene catalyst comprises a metallocene complex of Formula I

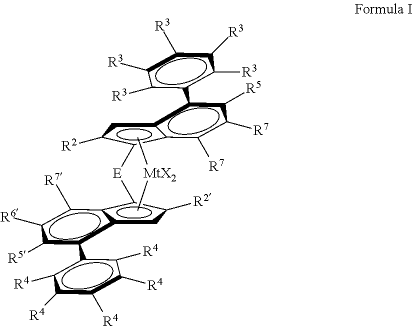

wherein Mt is Zr or Hf;

each X is a sigma-ligand;

E is a —CR¹₂—, —CR¹₂—CR¹₂—, —CR¹₂—SiR¹₂—, —SiR¹₂— or —SiR¹₂—SiR¹₂—group chemically linking the two cyclopentadienyl ligands; the R¹ groups, which can be the same or can be different, are hydrogen or C₁₋₂₀ hydrocarbyl groups, optionally containing up to 2 silicon, oxygen, sulphur or nitrogen atoms, and optionally two R¹ groups can be part of a C₄-C₈ ring,

R² and R^{2′} are the same or different from each other;

R² is a —CH₂R group, with R being H or a linear or branched C₁₋₆ alkyl group, C₃₋₈ cycloalkyl group, C₆₋₁₀ aryl group;

R² is a C₁₋₂₀ hydrocarbyl group; preferably, R² and R^{2′} are the same and are linear or branched C₁₋₆ alkyl groups;

each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY group wherein Y is a C₁₋₁₀ hydrocarbyl group, and optionally two adjacent R³ or R⁴ groups can be part of a ring including the phenyl carbons to which they are bonded;

each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY group wherein Y is a C₁₋₁₀ hydrocarbyl group, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;

R⁷ and R^{7′}, same or different from each other, are H or an OY group or a C₁₋₂₀ hydrocarbyl group optionally containing up to two silicon, oxygen, sulphur or nitrogen atoms, with the proviso that when R⁷═H, then both R⁵, R⁶≠H, and when R^{7′}═H, then both R^{5′}, R^{6′}≠H, and with the additional proviso that R⁵ and R⁶ can be hydrogen only when R⁷ is different from hydrogen and that R^{5′} and R^{6′} can be hydrogen only when R^{7′} is different from hydrogen; and

wherein step (II) takes place in at least one gas phase reactor operating at a reactor pressure of at least 26 bar.

Thus, viewed from one aspect the invention provides a heterophasic polypropylene resin comprising a polypropylene matrix phase (A) and an ethylene-propylene copolymer phase (B) dispersed within the matrix, wherein the ethylene-propylene copolymer phase (B) is an amorphous ethylene-propylene copolymer with an intrinsic viscosity (iV) measured in decalin at 135° C. of at least 3.5 dL/g and ethylene content of at least 15 wt %, comprising at least 4 long chain branches (LCB) per copolymer chain.

Viewed from another aspect, the invention provides a heterophasic polypropylene resin obtained or obtainable by a process as hereinbefore defined.

Viewed from a further aspect the invention provides the use of a heterophasic polypropylene resin as hereinbefore defined in the manufacture of an article, e.g. a flexible tube, pipe, profile, cable insulation, sheet, or film.

### BRIEF DESCRIPTION OF THE DRAWINGS

In the following the disclosure will be described in greater detail by means of preferred embodiments with reference to the accompanying drawings, in which

FIG. 1 illustrates variation of EPR intrinsic viscosity with pressure for gas phase temperature of 70° C. and copolymer ethylene content at about 25 wt %, with Cat1, Cat2, Cat3;

FIG. 2 illustrates variation of EPR intrinsic viscosity with pressure for gas phase temperatures of 70 and 90° C. and copolymer ethylene content at about 25 wt %, with Cat1 and Cat3;

FIG. 3 illustrates variation of EPR intrinsic viscosity with pressure for gas phase temperatures of 90° C. and copolymer ethylene content at about 25, 70 and 80 wt %, with Cat1 and Cat2;

FIG. 4 illustrates variation of C2/C3 relative reactivity ratio with pressure for gas phase temperature of 70° C. and copolymer ethylene content at about 25 wt %, with Cat1, Cat2, Cat3;

FIG. 5 illustrates variation of C2/C3 relative reactivity ratio with pressure for gas phase temperatures of 70 and 90° C. and copolymer ethylene content at about 25 wt %, with Cat1 and Cat3; and

FIG. 6 illustrates variation of C2/C3 relative reactivity ratio with pressure for gas phase temperatures of 90° C. and copolymer ethylene content at about 25, 70 and 80 wt %, with Cat1 and Cat2.

FIG. 7 illustrates the calculation of the linear reference line as well as the calculation of the g′₍₈₅₋₁₀₀₎.

### DETAILED DESCRIPTION OF THE DISCLOSURE

The invention provides a process for the preparation of a heterophasic polypropylene resin, in a multistage polymerisation process in the presence of a metallocene catalyst as discussed herein, said process comprising:
(I) in a first polymerisation step, performed in one or more reactors, polymerising propylene and optionally at least one C2-10 alpha olefin comonomer to obtain a polypropylene matrix phase (A); and subsequently
(II) in a second polymerisation step, polymerising propylene, ethylene and optionally at least one C4-10 alpha olefin comonomer, in the presence of the metallocene catalyst and polymer from step (I) to obtain an ethylene-propylene copolymer phase (B) dispersed in the matrix phase (A);

wherein step (II) takes place in at least one gas phase reactor operating at a reactor pressure of at least 26 bar.

The present invention further relates to heterophasic polypropylene resins containing an amorphous ethylene propylene copolymer having an intrinsic viscosity (iV) in a particular range as well as a particular C2 content and comprising at least 4 long chain branches (LCB) per copolymer chain.

### Polymerisation

The present invention relates to a multistage polymerisation process using a metallocene catalyst, said process comprising an optional but preferred prepolymerisation step, followed by a first and a second polymerisation step.

Preferably, the same catalyst is used in each step and ideally, it is transferred from prepolymerisation to subsequent polymerisation steps in sequence in a well-known manner. One preferred process configuration is based on a Borstar® type cascade.

Accordingly, the present process for the preparation of a heterophasic polypropylene resin, in a multistage polymerisation process in the presence of a metallocene catalyst as discussed herein, comprises:
(I) in a first polymerisation step, performed in one or more, preferably sequential, reactors, polymerising propylene and optionally at least one C2-10 alpha olefin comonomer; and subsequently
(II) in a second polymerisation step, polymerising propylene, ethylene and optionally at least one C4-10 alpha olefin comonomer, in the presence of the metallocene catalyst and polymer from step (I);

wherein said metallocene catalyst comprises a metallocene complex and preferably one or more cocatalyst(s) as discussed herein; and

wherein step (II) takes place in at least one gas phase reactor operating at a reactor pressure of at least 26 bar, wherein the process typically produces a heterophasic polypropylene resin as discussed herein.

Further as an example of the present process, the first polymerisation step (I) produces a polypropylene matrix phase (A) as discussed herein and the second polymerization step (II) produces a rubber component (B) (i.e. the amorphous ethylene propylene copolymer) as discussed herein.

### Prepolymerisation

The process of the invention may utilise an in-line prepolymerisation step. The in-line prepolymerisation step takes place just before the first polymerisation step (I) and may be effected in the presence of hydrogen although the concentration of hydrogen should be low if it is present. The concentration of hydrogen may be from 0 to 1 mol(hydrogen)/kmol(propylene), preferably from 0.001 to 0.1 mol(hydrogen)/kmol(propylene).

The temperature conditions within the prepolymerisation step are ideally kept low such as 0 to 50° C., preferably 5 to 40° C., more preferably 10 to 30° C.

The prepolymerisation stage preferably polymerises propylene monomer only. The residence time in the prepolymerisation reaction stage is short, typically 5 to 30 min.

The prepolymerisation stage preferably generates less than 5 wt % of the total polymer formed, such as 3 wt % or less.

Prepolymerisation preferably takes place in its own dedicated reactor, ideally in liquid propylene slurry. The prepolymerised catalyst is then transferred over to the first polymerisation step. However, it is also possible, especially in batch processes, that prepolymerisation is carried out in the same reactor as the first polymerisation step.

### First Polymerisation Step (I)—Polypropylene Matrix Phase Production

In the present invention, the first polymerisation step involves polymerising propylene and optionally at least one C2-10 alpha olefin comonomer. The first polymerization step (I) results in a polypropylene polymer matrix which if further modified in the second polymerisation step (II) to provide the desired amorphous polymer with unique properties.

Thus, in one embodiment, the first polymerisation step involves polymerising only propylene, so as to produce a propylene homopolymer.

In another embodiment, the first polymerisation step involves polymerising propylene together with at least one C2-10 alpha olefin. In this embodiment, the comonomer polymerised with the propylene may be ethylene or a C4-10 alpha olefin or a mixture of comonomers might be used such as a mixture of ethylene and a C4-10 α-olefin.

As comonomers to propylene are preferably used ethylene, 1-butene, 1-hexene, 1-octene or any mixtures thereof, preferably ethylene. When ethylene comonomer is present in the polymer produced in the first polymerisation step (I), its content may be up to 5 mol %, or 3.4 wt %, while when butene comonomer is present, then its content can be up to 5 mol %, or 6.6 wt %, provided that their combined content is at most 5 mol %, relative to the polymer as a whole.

The first polymerisation step may take place in any suitable reactor or series of reactors. The first polymerisation step may take place in a slurry polymerisation reactor such as a loop reactor or in a gas phase polymerisation reactor, or a combination thereof.

Where a slurry polymerisation reactor is employed, this is typically effected in at least one loop reactor. Ideally, the polymerisation takes place in bulk, i.e. in a medium of liquid propylene. For slurry reactors in general and in particular for bulk reactors, the reaction temperature will generally be in the range 60 to 100° C., preferably 70 to 85° C. The reactor pressure will generally be in the range 5 to 80 bar (e.g. 20 to 60 bar), and the residence time will generally be in the range 0.1 to 5 hours (e.g. 0.3 to 2 hours). When a gas phase reactor is employed, the reaction temperature will generally be in the range 60 to 120° C., preferably 70 to 90° C. The reactor pressure will generally be in the range 10 to 35 bar (e.g. 15 to 30 bar), and the residence time will generally be in the range 0.5 to 5 hours (e.g. 1 to 2 hours).

In a preferred embodiment, the first polymerisation step takes place in a slurry loop reactor connected in cascade to a gas phase reactor. In such scenarios, the polymer produced in the loop reactor is transferred into the first gas phase reactor.

It is preferred if hydrogen is used in the first polymerisation step. The amount of hydrogen employed is typically considerably larger than the amount used in the prepolymerisation stage.

### Second Polymerisation Step (II)—Rubber Phase Production

The second polymerisation step (II) of the process of the invention is a gas polymerisation step in which propylene, ethylene and optionally at least one C4-10 alpha olefin comonomer are polymerised in the presence of the metallocene catalyst and polymer from step (I). This polymerisation step takes place in at least one gas phase reactor, optionally in the presence of an inert gas such as propane. Thus, the second polymerisation step may take place in a single gas phase reactor or more than one gas phase reactor connected in series or parallel. The second polymerization step (II) results in production of the rubber phase dispersed in the semi-crystalline polypropylene matrix produced in the first polymerisation step (I) and is crucial in providing the desired amorphous polymer with unique properties.

The C4-10 alpha olefin may be, for example, 1-butene, 1-hexene, 1-octene or any mixtures thereof. Preferably, however, step (II) involves the polymerisation of propylene and ethylene only.

A key feature of the present invention is the reactor pressure in at least one gas phase reactor of the second polymerisation step (II). In the process of the invention, the reactor pressure is at least 26 bar, preferably at least 28 bar, more preferably at least 30 bar, even more preferably at least 35 bar, typically in the range of 26 to 60 bar, preferably in the range of 28 to 50 bar, more preferably in the range of 30 to 45 bar, even more preferably in the range from 30 to 38 bar. The maximum pressure reachable in gas phase obviously depends also on both temperature and gas composition (C2/C3 ratio and propane content). For the purpose of the present invention, the gas phase step is defined as such, when at least 80 wt %, preferably 90 wt % of the monomers present in the gas phase reactor are actually in gas phase, as calculated by vapour-liquid equilibria, e.g. by Aspen plus.

Increasing the gas phase reactor pressure, while keeping the same temperature and gas phase composition, leads to increased productivity, increased molecular weight of the rubber, and most important, increases the ethylene reactivity relative to propylene, enabling the production of polymers with a broader composition range and extending the process window in terms of achievable production split between bulk and gas phases steps, at a given reactor temperature.

In the process of the invention, the temperature in the gas phase reactor will generally be in the range of 60 to 120° C., preferably in the range of 65 to 110° C., more preferably in the range of 65 to 100° C., more preferably in the range of 70 to 90° C. Higher gas phase reactor temperatures will favour higher operating pressure and therefore will favour the inventive features of the process.

The residence time within any gas phase reactor will generally be 0.5 to 8 hours (e.g. 0.5 to 4 hours). The gas used will be the monomer mixture optionally as mixture with a non-reactive gas such as propane.

The hydrogen content within the gas phase reactor(s) is important for controlling polymer properties but is independent of the hydrogen added to prepolymerisation and first polymerisation steps. Hydrogen left in the reactor(s) of step I can be partially vented before a transfer to the gas phase reactor(s) of step II is effected, but it can also be transferred together with the polymer/monomer mixture of step I into the gas phase reactor(s) of step II, where more hydrogen can be added to control the molecular weight (Mw) of the rubber to the desired value.

In a particularly preferred embodiment of the invention, no hydrogen is added during the gas phase polymerisation step II.

The production ratio or split (by weight) between the first and second polymerisation steps is ideally 55:45 to 85:15, preferably 60:40 to 80:20. Note that any small amount of polymer formed in prepolymerisation is counted as part of the polymer prepared in the first polymerisation step.

### Metallocene Catalyst

The processes of the invention employ a metallocene catalyst. The metallocene complexes are preferably chiral, racemic bridged bisindenyl metallocenes in their anti-configuration. The metallocenes can be symmetric or asymmetric. Symmetric in this context means that the two indenyl ligands forming the metallocene complex are chemically identical, that is they have the same number and type of substituents. Asymmetrical means simply that the two indenyl ligands differ in one or more of their substituents, be it their chemical structure or their position on the indenyl moiety. In the case of asymmetrical metallocene complexes, although they are formally C₁-symmetric, they ideally retain a pseudo-C₂-symmetry since they maintain C₂-symmetry in close proximity of the metal centre although not at the ligand periphery. By nature of their chemistry both anti and syn enantiomer pairs (in case of C₁-symmetric complexes) or a racemic anti and a meso form (in case of C₂-symmetric complexes) are generated during the synthesis of the complexes. For the purpose of this invention, racemic-anti means that the two indenyl ligands are oriented in opposite directions with respect to the cyclopentadienyl-metal-cyclopentadienyl plane, while racemic-syn (or meso form) means that the two indenyl ligands are oriented in the same direction with respect to the cyclopentadienyl-metal-cyclopentadienyl plane, as shown as an example in the scheme below.

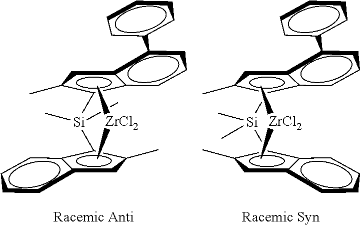

The following formulae are therefore intended to represent the racemic anti isomers of the metallocene complexes.

The metallocene complexes are preferably employed as the racemic-anti-isomers. Ideally, therefore at least 90 mol %, such as at least 95 mol %, especially at least 98 mol % of the metallocene catalyst complex is in the racemic anti-isomeric form.

For the purpose of this invention, the numbering scheme of the indenyl and indacenyl ligands is the following:

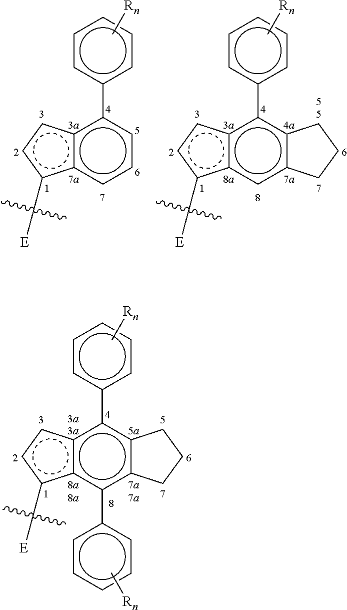

It will be appreciated that in the complexes of the invention, the metal ion Mt is coordinated by ligands X so as to satisfy the valency of the metal ion and to fill its available coordination sites. The nature of these σ-ligands can vary greatly.

The term “C₁₋₂₀ hydrocarbyl group” includes C₁₋₂₀ alkyl, C₂₋₂₀ alkenyl, C₂₋₂₀ alkynyl, C₃₋₂₀ cycloalkyl, C₃₋₂₀ cycloalkenyl, C₆₋₂₀ aryl groups, C₇₋₂₀ alkylaryl groups or C₇₋₂₀ arylalkyl groups or of course mixtures of these groups such as cycloalkyl substituted by alkyl. Linear and branched hydrocarbyl groups cannot contain cyclic units. Aliphatic hydrocarbyl groups cannot contain aryl rings.

Unless otherwise stated, preferred C₁₋₂₀ hydrocarbyl groups are C₁₋₂₀ alkyl, C₄₋₂₀ cycloalkyl, C₅₋₂₀ cycloalkyl-alkyl groups, C₇₋₂₀ alkylaryl groups, C₇₋₂₀ arylalkyl groups or C₆₋₂₀ aryl groups, especially C₁₋₁₀ alkyl groups, C₆₋₁₀ aryl groups, or C₇₋₁₂ arylalkyl groups, e.g. C₁₋₈ alkyl groups. Most especially preferred hydrocarbyl groups are methyl, ethyl, propyl, isopropyl, tertbutyl, isobutyl, C₅₋₆ -cycloalkyl, cyclohexylmethyl, phenyl or benzyl.

The term “halogen” includes fluoro, chloro, bromo, and iodo groups, especially chloro groups.

The metallocenes employed in the invention are bridged bisindenyl metallocenes in their racemic anti configuration, having the structure described by formula I:

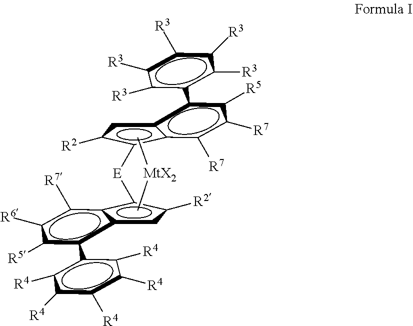

wherein Mt is Zr or Hf;

each X is a sigma-ligand;

E is a —CR¹₂—, —CR¹₂—CR¹₂—, —CR¹₂—SiR¹₂—, —SiR¹₂— or —SiR¹₂—SiR¹₂— group chemically linking the two cyclopentadienyl ligands; The R¹ groups, which can be the same or can be different, are hydrogen or C₁₋₂₀ hydrocarbyl groups, optionally containing up to 2 silicon, oxygen, sulphur or nitrogen atoms, and optionally two R¹ groups can be part of a C₄-C₈ ring,

R² and R^{2′} are the same or different from each other;

R² is a —CH₂R group, with R being H or a linear or branched C₁₋₆ alkyl group, C₃₋₈ cycloalkyl group, C₆₋₁₀ aryl group;

R^{2′} is a C₁₋₂₀ hydrocarbyl group; preferably, R² and R^{2′} are the same and are linear or branched C₁₋₆ alkyl groups;

each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY group wherein Y is a C₁₋₁₀ hydrocarbyl group, and optionally two adjacent R³ or R⁴ groups can be part of a ring including the phenyl carbons to which they are bonded;

each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY group wherein Y is a C₁₋₁₀ hydrocarbyl group, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;

R⁷ and R^{7′}, same or different from each other, are H or an OY group or a C₁₋₂₀ hydrocarbyl group optionally containing up to two silicon, oxygen, sulphur or nitrogen atoms, with the proviso that when R⁷═H, then both R⁵, R⁶≠H, and when R^{7′}═H, then both R^{5′}, R^{6′}≠H, and with the additional proviso that R⁵ and R⁶ can be hydrogen only when R⁷ is different from hydrogen and that R^{5′} and R^{6′} can be hydrogen only when R^{7′} is different from hydrogen.

For the above-defined Formula I, the following represent preferable embodiments, which can be selected alone or in combination:

E is preferably SiMe₂;

X is preferably halogen, more preferably CI, or methyl;

R² and R^{2′} are preferably C₁₋₆ alkyl, more preferably methyl;

R³ and R⁴ are, independently, preferably H or a linear or branched C₁₋₆ alkyl group, more preferably selected from the group consisting of H, t-butyl and methyl;

each R⁵, R^{5′}, R⁶ and R^{6′} are independently preferably independently a C₁₋₁₀ hydrocarbyl group, an OY group wherein Y is a C₁₋₆ alkyl group, or—CH═, —CY═, —CH₂—, —CHY— or —CY₂—groups that are part of a cyclic structure of 4 to 7 atoms, including the carbon atoms at positions 5 and 6 and/or 5′ and 6′ of the corresponding indenyl ligand;

R⁷ is preferably H, a C₁₋₂₀ alkyl group or a C6-20 aryl group; and/or

R^{7′} is preferably H.

Preferably, the metallocenes that are suitable for the invention are bridged bisindenyl metallocenes in their racemic anti configuration, having the structure described by formula

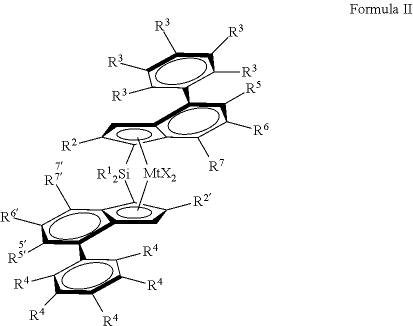

wherein Mt is Zr or Hf;

X, which can be the same or different from each other, are halogen, hydrogen, C₁₋₂₀ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;

the two R¹ groups on silicon, which can be the same or different from each other, are hydrogen or C₁₋₂₀ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;

R² and R^{2′} are the same or different from each other;

R² is a —CH₂R group, with R being H or a linear or branched C₁₋₆ alkyl group, C₃₋₈ cycloalkyl group, C₆₋₁₀ aryl group optionally containing up to 2 silicon, oxygen, sulphur or nitrogen atoms;

R^{2′} is a C₁₋₂₀ hydrocarbyl group optionally containing up to 2 silicon, oxygen, sulphur or nitrogen atoms; preferably, R² and R^{2′} are the same and are linear or branched C₁₋₆ alkyl groups;

each R³ and R⁴ are independently the same or can be different and are hydrogen, a linear or branched C₁₋₈ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;

each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY or NY₂ group wherein Y is a C₁₋₁₀ hydrocarbyl group, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;

R⁷ and R^{7′}, same or different from each other, are H or an OY group or a C₁₋₂₀ hydrocarbyl group optionally containing up to two silicon, oxygen, sulphur or nitrogen atoms, with the proviso that when R⁷═H, then both R⁵, R⁶≠H, and when R^{7′}═H, then both R^{5′}, R^{6′}≠H, and with the additional proviso that R⁵ and R⁶ can be hydrogen only when R⁷ is different from hydrogen and that R^{5′} and R^{6′} can be hydrogen only when R^{7′} is different from hydrogen;

For the above-defined Formula II, the following represent preferable embodiments, which can be selected alone or in combination:

R¹ is preferably methyl;

X is preferably halogen, more preferably CI, or methyl;

R² and R^{2′} are preferably C₁₋₆ alkyl, more preferably methyl;

R³ and R⁴ are, independently, preferably H or a linear or branched C₁₋₆ alkyl group, more preferably selected from the group consisting of H, t-butyl and methyl; each R⁵, R^{5′}, R⁶ and R^{6′} are independently preferably a C₁₋₁₀ hydrocarbyl group, an OY group wherein Y is a C₁₋₆ alkyl group, or—CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;

R⁷ is preferably H, a C₁₋₂₀ alkyl group or a C₆₋₂₀ aryl group; and/or

R^{7′} is preferably H.

Even more preferably, the metallocenes that are suitable for the invention are bridged bisindenyl metallocenes in their racemic anti configuration, having the structure described by formula III:

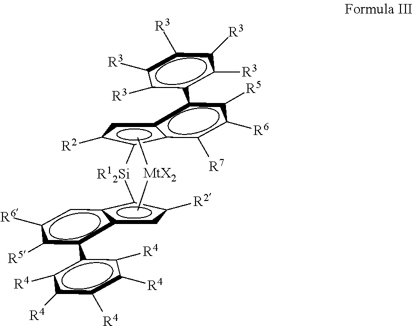

wherein Mt is Zr or Hf;

X, which can be the same or different from each other, are halogen, hydrogen, C₁₋₆ hydrocarbyl groups, or OY or NY₂ groups wherein Y is a C₁₋₆ hydrocarbyl group optionally containing 1 silicon atom;

the two R¹ groups on silicon, which can be the same or different from each other, are hydrogen or C₁₋₈ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;

R² and R^{2′} are the same or different from each other, and are a —CH₂R group, with R being H or a linear or branched C₁₋₆ alkyl group, C₃₋₈ cycloalkyl group, C₆₋₁₀ aryl group;

preferably, R² and R^{2′} are the same and are linear or branched C₁₋₆ alkyl groups;

each Wand R⁴ are independently the same or can be different and are hydrogen, a linear or branched C₁₋C₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;

each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY group wherein Y is a C₁₋₁₀ hydrocarbyl group, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;

R⁷ is H or an OY group or a C₁₋₂₀ hydrocarbyl group optionally containing up to two silicon, oxygen, sulphur or nitrogen atoms, with the proviso that when R⁷═H, then both R⁵, R⁶≠H, and with the additional proviso that R⁵ and R⁶ can be hydrogen only when R⁷ is different from hydrogen.

For the above-defined Formula III, the following represent preferable embodiments, which can be selected alone or in combination:

Mt is preferably Zr;

R¹ is preferably methyl;

X is preferably halogen, more preferably CI, or methyl;

R² and R^{2′} are preferably C₁₋₆ alkyl, more preferably methyl;

R³ and R⁴ are, independently, preferably H or a linear or branched C₁₋₆ alkyl group, more preferably selected from the group consisting of H, t-butyl and methyl;

each R⁵, R^{5′}, R⁶ and R^{6′} are independently preferably a C₁₋₁₀ hydrocarbyl group, an OY group wherein Y is a C₁₋₆ alkyl group, or—CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand; and/or

R⁷ is preferably H, a C₁₋₂₀ alkyl group or a C₆₋₂₀ aryl group.

In one embodiment, the metallocenes that are suitable for the invention are bridged bisindenyl metallocenes in their racemic anti configuration, having the structure described by formula IV:

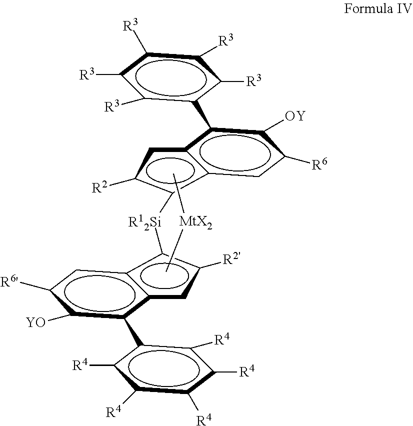

wherein Mt is Zr or Hf;

X, which can be the same or different from each other, are halogen, C₁₋₆ hydrocarbyl groups, or OY or NY₂ groups wherein Y is a C₁₋₆ hydrocarbyl group optionally containing 1 silicon atom;

the two R¹ groups on silicon, which can be the same or different from each other, are hydrogen or C₁₋₈ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl; most preferably, R¹ are the same and are Me;

R² and R^{2′} are the same or different from each other, and are a —CH₂R group, with R being H or a linear or branched C₁₋₆ alkyl group, C₃₋₈ cycloalkyl group, C₆₋₁₀ aryl group;

preferably, R² and R^{2′} are the same and are linear or branched C₁₋₆ alkyl groups;

each Wand R⁴ are independently the same or can be different and are hydrogen, a linear or branched C₁₋C₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or

R⁴ groups can be part of a 4-7 atom ring including the phenyl carbons to which they are bonded;

each R⁶ and R^{6′} are independently a C₁₋₂₀ hydrocarbyl group, optionally containing up to 2 silicon, oxygen, sulphur or nitrogen atoms; and

Y is a C₁₋₁₀ hydrocarbyl group.

For the above-defined Formula IV, the following represent preferable embodiments, which can be selected alone or in combination:

R¹ is preferably methyl;

X is preferably halogen, more preferably CI, or methyl;

R² and R^{2′} are preferably C₁₋₆ alkyl, more preferably methyl;

R³ and R⁴ are, independently, preferably H or a linear or branched C₁₋₆ alkyl group, more preferably selected from the group consisting of H, t-butyl and methyl;

Y is preferably a C₁₋₆ alkyl group, more preferably methyl; and/or

each R⁶ and R^{6′} are independently preferably a C₁₋₁₀ hydrocarbyl group.

In the same embodiment, more preferably the metallocenes have the structure described by formula V:

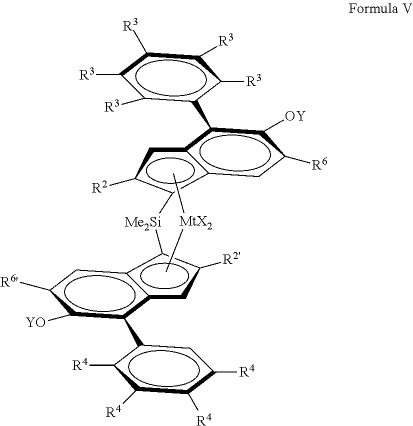

wherein Mt is Zr or Hf;

X, which can be the same or different from each other, are halogen, C₁₋₆ hydrocarbyl groups, or OY or NY₂ groups wherein Y is a C₁₋₆ hydrocarbyl group optionally containing 1 silicon atom;

R² and R^{2′} are the same or different from each other, and are a —CH₂ R group, with R being H or a linear or branched C₁₋₆ alkyl group, C₃₋₈ cycloalkyl group, C₆₋₁₀ aryl group;

preferably, R² and R^{2′} are the same and are linear or branched C₁₋₆ alkyl groups;

each R³ and R⁴ are independently the same or can be different and are hydrogen, a linear or branched C₁₋C₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;

each R⁶ and R^{6′} are independently a C₁₋₁₀ hydrocarbyl group; and

Y is a C₁₋₁₀ hydrocarbyl group.

For the above-defined Formula V, the following represent preferable embodiments, which can be selected alone or in combination:

X is preferably halogen, more preferably CI, or methyl;

R² and R^{2′} are preferably C₁₋₆ alkyl, more preferably methyl;

R³ and R⁴ are, independently, preferably H or a linear or branched C₁₋₆ alkyl group, more preferably selected from the group consisting of H, t-butyl and methyl;

Y is preferably a C₁₋₆ alkyl group, more preferably methyl; and/or

each R⁶ and R^{6′} are independently preferably a C₁₋₁₀ hydrocarbyl group.

In the same embodiment, even more preferably the metallocenes have the structure described by formula VI:

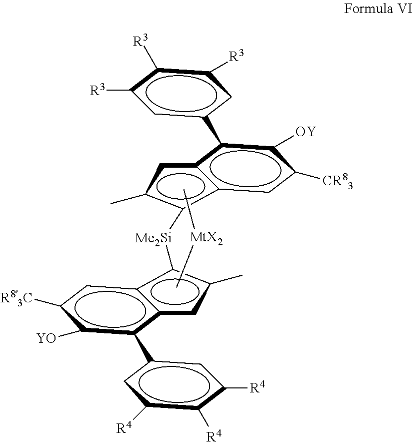

wherein Mt is Zr or Hf;

X, which can be the same or different from each other, are halogen, C₁₋₆ hydrocarbyl groups, or OY or NY₂ groups wherein Y is a C₁₋₆ hydrocarbyl group optionally containing 1 silicon atom;

each R³ and R⁴ are independently the same or can be different and are hydrogen, a linear or branched C₁₋C₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;

R⁵ and R^{5′} are independently a C₁₋₁₀ hydrocarbyl group;

R⁵ and R^{5′} are independently H or a C₁₋₁₀ hydrocarbyl group; and

Y is a C₁₋₁₀ hydrocarbyl group.

For the above-defined Formula VI, the following represent preferable embodiments, which can be selected alone or in combination:

X is preferably halogen, more preferably CI, or methyl;

R³ and R⁴ are, independently, preferably H or a linear or branched C₁₋₆ alkyl group, more preferably selected from the group consisting of H, t-butyl and methyl;

Y is preferably is a C₁₋₆ alkyl group, more preferably methyl; and/or each R⁵ and R^{5′} are independently preferably a C₁₋₁₀ hydrocarbyl group.

Preferred metallocenes in this embodiment are:
rac-dimethylsilanediylbis(2-methyl-4-phenyl-5-methoxy-6-tert-butylinden-1-yl) zirconium dichloride;
rac-dimethylsilanediylbis(2-methyl-4-(4′-tert-butylphenyl)-5-methoxy-6-tert-butylinden-1-y1) zirconium dichloride;
rac-dimethylsilanediylbis(2-methyl-4-(3′,5′-di-methyl phenyl)-5-methoxy-6-tert-butylinden-1-yl) zirconium dichloride;
rac-dimethylsilanediylbis(2-methyl-4-(3′,5′-di-tert-butylphenyl)-5-methoxy-6-tert-butylinden-1-yl) zirconium dichloride;
and their zirconium dimethyl and hafnium analogues.

In a second embodiment, the metallocenes that are suitable for the invention are bridged bisindenyl metallocenes in their racemic anti configuration, having the structure described by formula VII:

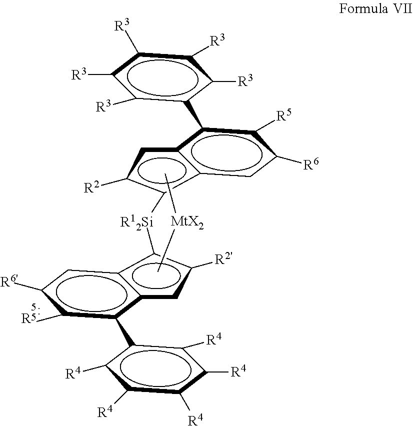

wherein Mt is Zr or Hf;

X, which can be the same or different from each other, are halogen, C₁₋₆ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;

the two R¹ groups on silicon, which can be the same or different from each other, are hydrogen or C₁₋₂₀ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;

R² and R^{2′} are the same or different from each other;

R² is a —CH₂ R group, with R being H or a linear or branched C₁₋₆ alkyl group, C₃₋₈ cycloalkyl group, C₆₋₁₀ aryl group optionally containing up to 2 silicon, oxygen, sulphur or nitrogen atoms;

R^{2′} is a C₁₋₂₀ hydrocarbyl group optionally containing up to 2 silicon, oxygen, sulphur or nitrogen atoms; preferably, R² and R^{2′} are the same and are linear or branched C₁₋₆ alkyl groups;

each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;

each R⁵, R^{5′}, R⁶ and R^{6′} are independently a C₁₋₂₀ hydrocarbyl group, optionally containing up to 2 silicon, oxygen, sulphur or nitrogen atoms, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand.

For the above-defined Formula VII, the following represent preferable embodiments, which can be selected alone or in combination:

R¹ is preferably methyl;

X is preferably halogen, more preferably CI, or methyl;

R² and R^{2′} are preferably C₁₋₆ alkyl, more preferably methyl;

R³ and R⁴ are, independently, preferably H or a linear or branched C₁₋₆ alkyl group, more preferably selected from the group consisting of H, t-butyl and methyl; and/or

each R⁵, R^{5′}, R⁶ and R^{6′} are independently preferably —CH═, —CY═, —CH₂—, —CHY— or —CY₂—groups that are part of a cyclic structure of 4 to 7 atoms, including the carbon atoms at positions 5 and 6 and/or 5′ and 6′ of the corresponding indenyl ligand.

In this second embodiment, the metallocenes have more preferably the structure described by formula VIII:

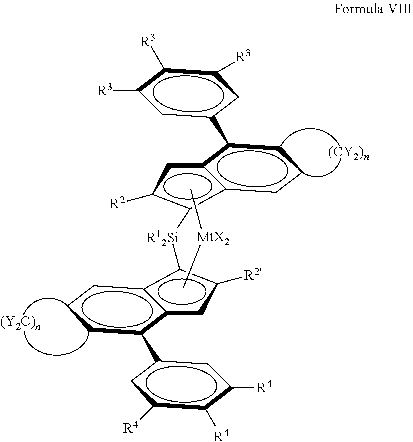

wherein Mt is Zr or Hf;

X, which can be the same or different from each other, are halogen, C₁₋₆ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;

the two R¹ groups on silicon, which can be the same or different from each other, are hydrogen or C₁₋₂₀ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;

R² and R^{2′} are the same or different from each other;

R² is a —CH₂ R group, with R being H or a linear or branched C₁₋₆ alkyl group, C₃₋₈ cycloalkyl group, C₆₋₁₀ aryl group optionally containing up to 2 silicon, oxygen, sulphur or nitrogen atoms;

R^{2′} is a C₁₋₂₀ hydrocarbyl group optionally containing up to 2 silicon, oxygen, sulphur or nitrogen atoms; preferably, R² and R^{2′} are the same and are linear or branched C₁₋₆ alkyl groups;

each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded; and

Y is a C₁₋₁₀ hydrocarbyl group and n is an integer between 2 and 5.

For the above-defined Formula VIII, the following represent preferable embodiments, which can be selected alone or in combination:

R¹ is preferably methyl;

X is preferably halogen, more preferably CI, or methyl;

R² and R^{2′} are preferably C₁₋₆ alkyl, more preferably methyl;

R³ and R⁴ are, independently, preferably H or a linear or branched C₁₋₆ alkyl group, more preferably selected from the group consisting of H, t-butyl and methyl; and/or

Y is a C₁₋₁₀ hydrocarbyl group and n is an integer between 3 and 4;

In this second embodiment, the metallocenes have even more preferably the structure described by formula IX:

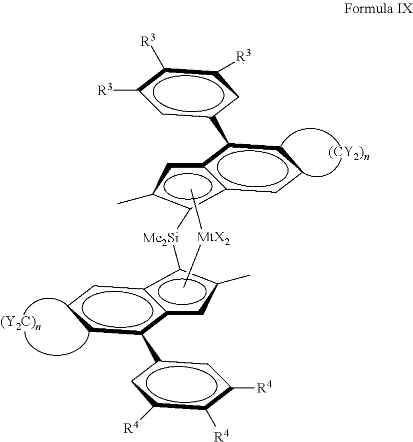

wherein Mt is Zr or Hf;

X, which can be the same or different from each other, are halogen, C₁₋₆ hydrocarbyl groups, optionally containing up to 2 silicon, oxygen, sulphur or nitrogen atoms, or OY or NY2 groups wherein Y is a C₁₋₁₀ hydrocarbyl group optionally containing up to 2 silicon atoms; most preferably X is chloro or methyl;

each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded; and

Y is a C₁₋₁₀ hydrocarbyl group and n is an integer between 3 and 4.

For the above-defined Formula IX, the following represent preferable embodiments, which can be selected alone or in combination:

Mt is preferably Zr;

X is preferably halogen, more preferably CI, or methyl;

R³ and R⁴ are, independently, preferably H or a linear or branched C₁₋₆ alkyl group, more preferably selected from the group consisting of H, t-butyl and methyl; and/or

Y is a C₁₋₁₀ hydrocarbyl group and n is an integer between 3 and 4.

Preferred metallocenes in this embodiment are:
rac-dimethylsilanediylbis[2-methyl-4-phenyl-1,5,6,7-tetrahydro-s-indacen-1-yl] zirconium dichloride;
rac-dimethylsilanediylbis[2-methyl-4-(4-tert-butylphenyl)-1,5,6,7-tetrahydro-s-indacen-1-yl] zirconium dichloride;
rac-dimethylsilanediylbis[2-methyl-4-(3,5-dimethylphenyl)-1,5,6,7-tetrahydro-s-indacen-1-yl] zirconium dichloride;
rac-dimethylsilanediylbis[2-methyl-4-(3′,5′-di-tert-butylphenyl)-1,5,6,7-tetrahydro-s-indacen-1-yl] zirconium dichloride;

and their zirconium dimethyl and hafnium analogues.

In a third embodiment, the metallocenes that are suitable for the invention are asymmetric bridged bisindenyl metallocenes in their racemic anti configuration, having the structure described by formula X:

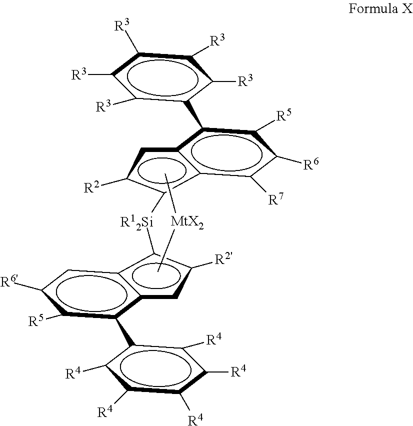

wherein Mt is Zr or Hf;

X, which can be the same or different from each other, are halogen, hydrogen, C₁₋₂₀ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;

the two R¹ groups on silicon, which can be the same or different from each other, are hydrogen or C₁₋₂₀ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;

R² and R^{2′} are the same or different from each other;

R² is a —CH₂ R group, with R being H or a linear or branched C₁₋₆ alkyl group, C₃₋₈ cycloalkyl group, C₆₋₁₀ aryl group optionally containing up to 2 silicon, oxygen, sulphur or nitrogen atoms;

R^{2′} is a C₁₋₂₀ hydrocarbyl group optionally containing up to 2 silicon, oxygen, sulphur or nitrogen atoms; preferably, R² and R^{2′} are the same and are linear or branched C₁₋₆ alkyl groups;

each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;

R⁵, R⁶ are independently hydrogen or a C₁₋₂₀ hydrocarbyl group, optionally containing up to 2 silicon, oxygen, sulphur or nitrogen atoms, and can be —CH═, —CY═, —CH₂—, —CHY— or —CY₂— groups that are part of a cyclic structure of 4 to 7 atoms, including the carbon atoms at positions 5 and 6 of the corresponding indenyl ligand;

R^{5′}, R^{6′} are a C₁₋₂₀ hydrocarbyl group, optionally containing up to 2 silicon, oxygen, sulphur or nitrogen atoms, or an OY or NY₂ group wherein Y is a C₁₋₁₀ hydrocarbyl group;

R⁷ is a C₁₋₂₀ hydrocarbyl group optionally containing up to two silicon, oxygen, sulphur or nitrogen atoms.

For the above-defined Formula X, the following represent preferable embodiments, which can be selected alone or in combination:
R¹ is preferably methyl;
X is preferably halogen, more preferably CI, or methyl;
R² and R^{2′} are preferably C₁₋₆ alkyl, more preferably methyl;
R³ and R⁴ are, independently, preferably H or a linear or branched C₁₋₆ alkyl group, more preferably selected from the group consisting of H, t-butyl and methyl;
each R⁵, R^{5′}, R⁶ and R^{6′} are independently preferably a C₁₋₁₀ hydrocarbyl group, an OY group wherein Y is a C₁₋₆ alkyl group, or—CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand; and/or
R⁷ is preferably a C₆₋₂₀ aryl group.

More preferably, the metallocenes of this third embodiment are asymmetric bridged bisindenyl metallocenes in their racemic anti configuration, having the structure described by formula XI:

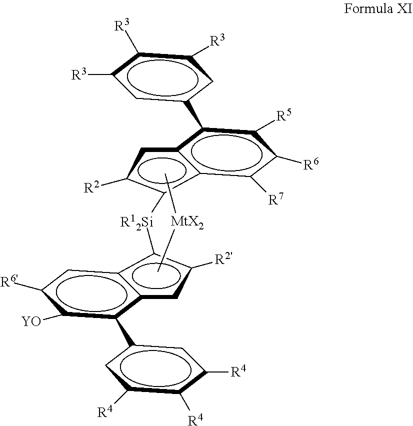

wherein Mt is Zr or Hf;

X, which can be the same or different from each other, are halogen, C₁₋₆ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;

the two R¹ groups on silicon, which can be the same or different from each other, are hydrogen or C₁₋₂₀ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;

R² and R^{2′} are the same or different from each other;

R² is a —CH₂R group, with R being H or a linear or branched C₁₋₆ alkyl group, C₃₋₈ cycloalkyl group, C₆₋₁₀ aryl group optionally containing up to 2 silicon, oxygen, sulphur or nitrogen atoms;

R^{2′} is a C₁₋₂₀ hydrocarbyl group optionally containing up to 2 silicon, oxygen, sulphur or nitrogen atoms; preferably, R² and R^{2′} are the same and are linear or branched C₁₋₆ alkyl groups;

each R³ and R⁴ are independently the same or can be different and are hydrogen, a linear or branched C₁₋₈ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or

R⁴ groups can be part of a 4-7 atom ring including the phenyl carbons to which they are bonded;

R⁵, R⁶ are independently hydrogen or a C₁₋₂₀ hydrocarbyl group, optionally containing up to 2 silicon, oxygen, sulphur or nitrogen atoms, and can be —CH═, —CY═, —CH₂—, —CHY— or —CY₂— groups that are part of a cyclic structure of 4 to 7 atoms, including the carbon atoms at positions 5 and 6 of the corresponding indenyl ligand;

R^{5′}, R^{6′} are a C₁₋₂₀ hydrocarbyl group;

R⁷ is a C₁₋₂₀ hydrocarbyl group optionally containing up to two silicon, oxygen, sulphur or nitrogen atoms; and

Y is a C₁₋₁₀ hydrocarbyl group.

For the above-defined Formula XI, the following represent preferable embodiments, which can be selected alone or in combination:
R¹ is preferably methyl;
X is preferably halogen, more preferably CI, or methyl;
R² and R^{2′} are preferably C₁₋₆ alkyl, more preferably methyl;
R³ and R⁴ are, independently, preferably H or a linear or branched C₁₋₆ alkyl group, more preferably selected from the group consisting of H, t-butyl and methyl;
each R⁵ and R⁶ are independently preferably —CH═, —CY═, —CH₂—, —CHY— or —CY₂— groups that are part of a cyclic structure of 4 to 7 atoms, including the carbon atoms at positions 5 and 6 of the corresponding indenyl ligand;
R^{6′} is preferably a C₁₋₁₀ hydrocarbyl group;
R⁷ is preferably a C₆₋₂₀ aryl group; and/or
Y is C₁₋₆ hydrocarbyl.

Even more preferably, the metallocenes of this third embodiment are asymmetric bridged bisindenyl metallocenes in their racemic anti configuration, having the structure described by formula XII:

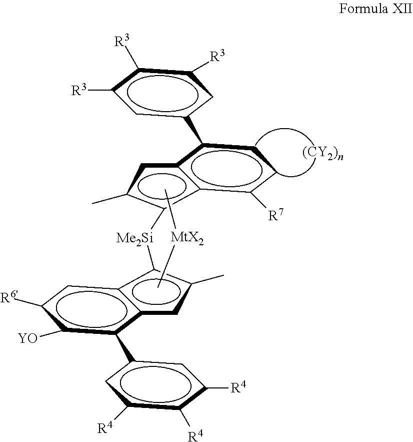

wherein Mt is Zr or Hf;

X, which can be the same or different from each other, are halogen, C₁₋₆ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;

each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;

R^{5′}, R^{6′} are a C₁₋₂₀ hydrocarbyl group;

Y is a C₁₋₁₀ hydrocarbyl group and n is an integer between 3 and 4.

For the above-defined Formula XII, the following represent preferable embodiments, which can be selected alone or in combination:

X is preferably halogen, more preferably CI, or methyl;

R³ and R⁴ are, independently, preferably H or a linear or branched C₁₋₆ alkyl group, more preferably selected from the group consisting of H, t-butyl and methyl;

Y is a C₁₋₆ hydrocarbyl group and n is 3;

R^{6′} is preferably a C₁₋₁₀ hydrocarbyl group; and/or

R⁷ is preferably a C₆₋₂₀ aryl group.

Most preferably, the metallocenes of this third embodiment are asymmetric bridged bisindenyl metallocenes in their racemic anti configuration, having the structure described by formula XIII:

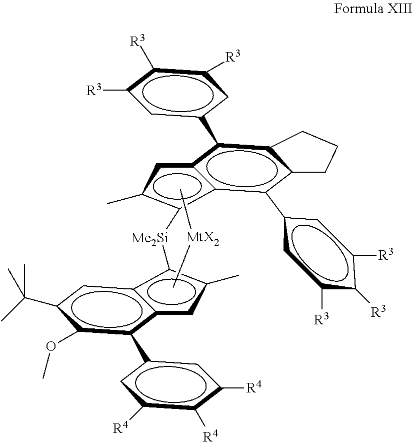

wherein Mt is Zr or Hf;

X, which can be the same or different from each other, are halogen, C₁₋₆ hydrocarbyl groups, or OY or NY₂ groups wherein Y is a C₁₋₁₀ hydrocarbyl group optionally containing up to 2 silicon atoms; most preferably X is chloro or methyl;

each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded.

For the above-defined Formula XIII, the following represent preferable embodiments, which can be selected alone or in combination:

X is preferably halogen, more preferably CI, or methyl; and/or

R³ and R⁴ are, independently, preferably H or a linear or branched C₁₋₆ alkyl group, more preferably selected from the group consisting of H, t-butyl and methyl.

Preferred metallocenes in this embodiment are:
rac-anti-dimethylsilanediyl[2-methyl-4,8-bis(4′-tert-butylphenyl)-1,5,6,7-tetrahydro-s-indacen-1-yl][2-methyl-4-(3′,5′-dimethylphenyl)-5-methoxy-6- tert-butylinden-1-yl]zirconium dichloride;
rac-anti-dimethylsilanediyl[2-methyl-4,8-bis(3′,5′-dimethyl phenyl)-1,5,6,7-tetrahydro-s-indacen-1-yl][2-methyl-4-(3′,5′-dimethylphenyl)-5-methoxy-6-tert-butylinden-1-yl]zirconium dichloride;
rac-anti-dimethylsilanediyl[2-methyl-4,8-bis(3′,5′-dimethyl phenyl)-1,5,6,7-tetrahydro-s-indacen-1-yl][2-methyl-4-(3′,5′-di-tert-butylphenyl)-5-methoxy-6-tert-butylinden-1-yl]zirconium dichloride;
rac-anti-dimethylsilanediyl[2-methyl-4,8-bis(4′-tert-butylphenyl)-1,5,6,7-tetrahydro-s-indacen-1-yl][2-methyl-4-(4′-tert-butylphenyl)-5-methoxy-6-tert- butylinden-1-yl]zirconium dichloride;
rac-anti-dimethylsilanediyl[2-methyl-4,8-bis(4′-tert-butylphenyl)-1,5,6,7-tetrahydro-s-indacen-1-yl][2-methyl-4-(3′,5′-di-tert-butylphenyl)-5-methoxy-6-tert-butylinden-1-yl]zirconium dichloride;
and their zirconium dimethyl and hafnium analogues.

For the avoidance of doubt, any narrower definition of a substituent offered above can be combined with any other broad or narrowed definition of any other substituent.

Throughout the disclosure above, where a narrower definition of a substituent is presented, that narrower definition is deemed disclosed in conjunction with all broader and narrower definitions of other substituents in the application.

### Cocatalyst

To form an active catalytic species it is normally necessary to employ a cocatalyst as is well known in the art. Cocatalysts comprising one or more compounds of Group 13 metals, like organoaluminium or organoboron or borate compounds used to activate metallocene catalysts are suitable for use in this invention.

The catalyst systems employed in the current invention may comprise (i) a complex as defined herein; and normally (ii) an aluminium alkyl compound (or other appropriate cocatalyst), or the reaction product thereof. Thus the cocatalyst is preferably an alumoxane, like methylalumoxane (MAO).

The aluminoxane cocatalyst can be one of formula (XX):

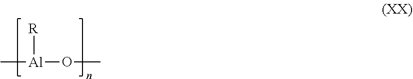

where n is usually from 6 to 20 and R has the meaning below.

Alumoxanes are formed for example by partial hydrolysis of organoaluminum compounds, for example those of the formula AIR₃ where R can be, for example, H, C1-C10 alkyl, preferably C1-C5 alkyl, or C3-10-cycloalkyl, C7-C12 -arylalkyl or alkylaryl and/or phenyl or naphthyl. The resulting oxygen-containing alumoxanes are not in general pure compounds but mixtures of oligomers of the formula (XX).

The preferred alumoxane is methylalumoxane (MAO). Since the alumoxanes used according to the invention as cocatalysts are not, owing to their mode of preparation, pure compounds, the molarity of alumoxane solutions hereinafter is based on their aluminium content.

According to the present invention, also a boron containing cocatalyst can be used instead of, or in combination with, the alumoxane cocatalyst

It will be appreciated by the skilled person that where boron based cocatalysts are employed in the absence of alumoxane, it is normal to pre-alkylate the complex by reaction thereof with an aluminium alkyl compound, such as TIBA. This procedure is well known and any suitable aluminium alkyl, e.g. Al(C₁₋₆-alkyl)₃. can be used. Preferred aluminium alkyl compounds are triethylaluminium, tri-isobutylaluminium, tri-isohexylaluminium, tri-n-octylaluminium and tri-isooctylaluminium.

Alternatively, when a borate cocatalyst is used in the absence of alumoxane, the metallocene catalyst complex is in its alkylated version, that is for example a dimethyl or dibenzyl metallocene catalyst complex can be used.

Boron based cocatalysts of interest include those of formula (Z)

BY₃ (Z)

wherein Y is the same or different and is a hydrogen atom, an alkyl group of from 1 to about 20 carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred examples for Y are haloaryl like p-fluorophenyl, 3,5-difluorophenyl, pentafluorophenyl, 3,4,5-trifluorophenyl and 3,5-di(trifluoromethyl)phenyl. Preferred options are trifluoroborane, tris(4-fluorophenyl)borane, tris(3,5-difluorophenyl)borane, tris(4-fluoromethylphenyl)borane, tris(2,4,6-trifluorophenyl)borane, tris(penta-fluorophenyl)borane, tris(3,5-difluorophenyl)borane and/or tris (3,4,5-trifluorophenyl)borane.

Particular preference is given to tris(pentafluorophenyl)borane.

However it is preferred that borates are used, i.e. compounds containing a borate anion and an acidic cation. Such ionic cocatalysts preferably contain a non-coordinating anion such as tetrakis(pentafluorophenyl)borate. Suitable cations are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

Preferred ionic compounds which can be used according to the present invention include:
tributylammoniumtetra(pentafluorophenyl)borate;
tributylammoniumtetra(trifluoromethylphenyl)borate;
tributylammoniumtetra(4-fluorophenyl)borate;
N,N-dimethylcyclohexylammoniumtetrakis(pentafluorophenyl)borate;
N,N-dimethylbenzylammoniumtetrakis(pentafluorophenyl)borate;
N,N-dimethylaniliniumtetrakis(pentafluorophenyl)borate;
N,N-di(propyl)ammoniumtetrakis(pentafluorophenyl)borate;
di(cyclohexyl)ammoniumtetrakist(pentafluorophenyl)borate;
triphenylcarbeniumtetrakis(pentafluorophenyl)borate; and
ferroceniumtetrakis(pentafluorophenyl)borate.
Preference is given to triphenylcarbeniumtetrakis(pentafluorophenyl) borate, N,N-dimethylaniliniumtetrakis(pentafluorophenyl)borate;
N,N-dimethylcyclohentlammoniumtetrakis(pentafluorophenyl)borate; and
N,N-dimethylbenzylammoniumtetrakis(pentafluorophenyl)borate.

In particular, triphenylcarbeniumtetrakis(pentafluorophenyl)borate and N,N-dimethylaniliniumtetrakis(pentafluorophenyl)borate are especially preferred.

Thus the use of Ph₃ CB(PhF₅)₄ and analogues therefore are especially favoured.

According to the present invention, the preferred cocatalysts are alumoxanes, more preferably methylalumoxanes in combination with a borate cocatalyst such as N,N-dimethylammonium-tetrakispentafluorophenylborate and Ph₃CB(PhF₅)₄. The combination of methylalumoxane and a tritylborate is especially preferred.

Suitable amounts of cocatalyst will be well known to the skilled person.

The molar ratio of feed amounts of boron to the metal ion of the metallocene may be in the range 0.1:1 to 10:1 mol/mol, preferably 0.3:1 to 7:1, especially 0.3:1 to 5:1 mol/mol.

The molar ratio of Al in the aluminoxane to the metal ion of the metallocene may be in the range 1:1 to 2000:1 mol/mol, preferably 10:1 to 1000:1, and more preferably 50:1 to 500:1 mol/mol.

The metallocene catalyst may contain from 10 to 100 μmol of the metal ion of the metallocene per gram of silica, and 5 to 10 mmol of Al per gram of silica.

### Catalyst Manufacture

The metallocene catalysts can be used in supported or unsupported form. The particulate support material used is preferably an organic or inorganic material, such as silica, alumina or zirconia or a mixed oxide such as silica-alumina, in particular silica, alumina or silica-alumina. The use of a silica support is preferred. The skilled person is aware of the procedures required to support a metallocene catalyst.

Especially preferably the support is a porous material so that the complex may be loaded into the pores of the support, e.g. using a process analogous to those described in WO94/14856 (Mobil), WO95/12622 (Borealis) and WO2006/097497. The particle size is not critical but is preferably in the range 5 to 200 μm, more preferably 20 to 80 μm. The use of these supports is routine in the art. Especially preferred procedures for producing such supported catalysts are those described in WO 2020/239598 and WO 2020/239603.

In another embodiment, no external carrier is used but the catalyst is still presented in solid particulate form. Thus, no external support material, such as inert organic or inorganic carrier, for example silica as described above is employed. Such catalysts can be prepared as described for example in WO 2003/051934, WO 2014/060540 and WO 2019/179959

### Amorphous Ethylene Propylene Copolymer

The amorphous ethylene propylene copolymer of the invention is a copolymer comprising ethylene and propylene. The ethylene propylene copolymer is soluble in 1,2,4-trichlorobenzene (TCB) and in xylene at 23° C. The solubility of the ethylene propylene copolymer in TCB and xylene may be determined as discussed in “Measurement methods—Determination of xylene soluble fraction”.

It is possible for the ethylene propylene copolymer to contain comonomers other than ethylene and propylene such as other for example C₄₋₂₀ olefins, e.g. 1-butene, 1-hexene, 4-methyl-1-pentene, 1-octene etc. Thus, in one embodiment, the EPR component may be an ethylene-propylene-alpha-olefin terpolymer, such as a propylene-ethylene-1-butene copolymer. However, it is preferred if no other comonomers are present.

The ethylene propylene copolymer can be unimodal or multimodal (e.g bimodal) with respect to the molecular weight distribution and/or the comonomer distribution.

In one embodiment, the copolymer is unimodal. More particularly, the copolymer is preferably unimodal with respect to the molecular weight distribution and/or the comonomer distribution.

The ethylene propylene copolymer is preferably an isotactic copolymer.

The ethylene content of the ethylene propylene copolymer is preferably at least 15 wt %, more preferably at least 20 wt %, even more preferably at least 21 wt %, such as at least 22 wt %, e.g. at least 24 wt %, relative to the total weight of the copolymer. Suitable ranges for the ethylene content of the copolymer may therefore be 20 to 80 wt %, such as 22 to 75 wt %, relative to the total weight of the copolymer.

The intrinsic viscosity (iV) of the ethylene propylene copolymer is at least 3.5 dl/g, preferably at least 4.0 dl/g, more preferably at least 4.5 dl/g, when determined in decahydronaphthalene (decalin, DHN) at 135° C. according to DIN EN ISO 1628-1 and -3. Suitable ranges for the intrinsic viscosity (iV) of the copolymer are 3.5 to 8.0 dl/g, preferably 4.0 to 7.5 dl/g, more preferably 4.5 to 7.0 dl/g, when determined according to DIN EN ISO 1628-1 and -3.

The ethylene propylene copolymer preferably has an Mw of at least 300,000 Da, more preferably at least 350,000 Da, more preferably at least 400,000 Da, determined as discussed in the “Measurement methods—GPC Analysis”.

A unique feature of the ethylene propylene copolymer of the invention is that, in combination with an intrinsic viscosity (iV) of at least 3.5 dl/g, it comprises at least 4 long chain branches (LCB) per ethylene propylene copolymer chain.

The number of LCB per copolymer chain may be determined as discussed in “Measurement methods—Branching Calculation”. Preferably, the ethylene propylene copolymer comprises at least 5 LCBs per copolymer chain, even more preferably at least 6 LCBs per copolymer chain. In an aspect of the invention, the ethylene propylene copolymer comprises at least 8 LCBs per copolymer chain, even more preferably at least 9 LCBs per copolymer chain, e.g. from 5 to 30, preferably from 6 to 25, more preferably from 8 to 20, even more preferably from 9 to 15.

In a preferred aspect on the invention, the ethylene propylene copolymer preferably has an Mw of at least 350,000 Da, preferably at least 400,000 Da, and an iV of at least 4.0 dl/g, preferably at least 4.5, more preferably from 4.0 dl/g to 7.5 dl/g, and contains at least at least 5 LCBs per copolymer chain.

The said LCBs are typically constituted of ethylene and propylene and do not contain crystallisable propylene sequences. This can be determined by ¹³C-NMR and DSC experiments as well known in the art.

The ethylene propylene copolymer may be prepared by any suitable method. Preferably, however, it is made in at least one gas phase reactor operating at a reactor pressure of at least 26 bar, in particular as discussed herein in context of the present process.

### Heterophasic Polypropylene Resin

The heterophasic polypropylene resin of the invention (HECO) comprises a crystalline or semi-crystalline propylene homopolymer or random propylene copolymer component, which is the polypropylene matrix phase (A), in which an amorphous propylene-ethylene copolymer (B) is dispersed (rubber phase, such as EPR).

Thus, the polypropylene matrix phase (A) contains (finely) dispersed inclusions being not part of the matrix and said inclusions contain the amorphous copolymer (B).

The term “heterophasic polypropylene resin” used herein denotes copolymers comprising a matrix resin, being a polypropylene homopolymer or a propylene copolymer and a predominantly amorphous copolymer (B) dispersed in said matrix resin, as defined in more detail below.

In the present invention, the term “matrix” is to be interpreted in its commonly accepted meaning, i.e. it refers to a continuous phase (in the present invention a continuous polymer phase) in which isolated or discrete particles such as rubber particles may be dispersed. The propylene polymer is present in such an amount that it forms a continuous phase which can act as a matrix.

The resins of the invention preferably comprise an isotactic propylene matrix component (A). Component (A) may consist of a single propylene polymer but (A) may also comprise a mixture of different propylene polymers. The same applies for component (B): it may consist of a single polymer, but may also comprise a mixture of different EPR's.

In a preferred embodiment therefore, the resin consists essentially of components (A) and (B). The “consists essentially of” wording is used herein to indicate the absence of other polyolefinic components. It will be appreciated that polymers contain additives and these may be present.

The heterophasic polypropylene resin according to the present invention is typically produced by sequential polymerization. Preferably, in at least one step the polypropylene matrix phase (A) is produced, and in at least one subsequent step the amorphous propylene-ethylene copolymer (B) is produced in the presence of the polypropylene matrix phase (A).

In order to characterize the matrix phase and the amorphous phase of a heterophasic propylene resin several methods are known.

The crystalline fraction and a soluble fraction may be separated with the CRYSTEX method using 1,2,4-trichlorobenzene (TCB) as solvent. This method is described below in the measurement methods section. In this method, a crystalline fraction (CF) and a soluble fraction (SF) are separated from each other. The crystalline fraction (CF) largely corresponds to the matrix phase and contains only a small part of the amorphous phase, while the soluble fraction (SF) largely corresponds to the amorphous phase and contains only a negligible (e.g. less than 0.5 wt %) part of the matrix phase. Thus, in the context of the present invention, the term “crystalline fraction (CF)” refers to component (A) and “soluble fraction (SF)” refers to component (B).

It is required that the polypropylene matrix phase (A) is at least partially crystalline thus ensuring that the resin as a whole comprises a crystalline phase and an amorphous phase.

It is preferred that the heterophasic polypropylene resin has a melting point (Tm) of 100 to 165° C., preferably 110 to 165° C., especially 120 to 165° C.

It is preferred if the heterophasic polypropylene resin has an MFR₂ (melt flow rate measured according to ISO1133 at 230° C. with 2.16 kg load) of 0.1 to 200 g/10 min, more preferably 1.0 to 100 g/10 min, such as 2.0 to 50 g/10 min.

It is preferred if the heterophasic polypropylene resin has an Mw/Mn of 2.0 to 5.0, such as 2.5 to 4.5.

Preferably there is at least 40 wt % of component (A) present in the heterophasic polypropylene resins of the invention, such as 45 to 90 wt %, more preferably 50 wt % to 85 wt % relative to the total weight of the heterophasic polypropylene resin.

Alternatively viewed, there should ideally be at least 40 wt % of a crystalline fraction present in the heterophasic polypropylene resins of the invention, such as 45 to 90 wt %, more preferably 50 wt % to 85 wt % of a crystalline fraction relative to the total weight of the heterophasic polypropylene resin.

There is preferably at least 10 wt % of the EPR (B) fraction present and preferably less than 60 wt % of component (B). Amounts of component (B) are preferably in the range of 10 to 55 wt %, ideally 15 to 50 wt % relative to the total weight of the heterophasic polypropylene resin.

Alternatively viewed, the soluble fraction (SF) of the heterophasic resin of the invention is preferably from 10 to less 60 wt %, such as 10 to 55 wt %, ideally 15 to 50 wt % relative to the total weight of the heterophasic polypropylene resin.

It will be appreciated that the amount of soluble fraction should essentially be the same as the amount of component (B) present as component (A) should contain almost no soluble components. Component (B) on the other hand is completely soluble.

It is also a preferred feature of the invention that the intrinsic viscosity (iV) of the SF of the resin is larger than the intrinsic viscosity (iV) of the CF of the resin. Intrinsic viscosity (iV) is a measure of molecular weight and thus the SF of the resin can be considered to have a higher Mw (weight average molecular weight) than the CF.

The iV of the polymer as a whole may be 0.9 to 7.0 dl/g, preferably in the range of 1.0 to 6.0 dl/g.

### Polypropylene Matrix Phase (A):

The polypropylene matrix phase (A) of the heterophasic polypropylene resin is at least partially crystalline. The matrix therefore may be a crystalline or semi-crystalline propylene homopolymer or random propylene copolymer component, or a combination thereof. The term “semicrystalline” indicates that the copolymer has a well-defined melting point and a heat of fusion higher than 50 J/g when analysed by DSC as a pure component. It is preferred if the matrix phase is at least partially crystalline thus ensuring that the polymer as a whole comprises a crystalline phase and an amorphous phase.

In one embodiment the polypropylene matrix phase (A) comprises a homopolymer of propylene as defined below, preferably consists of a homopolymer of propylene as defined below. The expression “homopolymer” used in the instant invention relates to a polypropylene that consists substantially of propylene units. In a preferred embodiment, only propylene units in the propylene homopolymer are detectable.

The homopolymer of propylene is isotactic polypropylene, with an isotactic pentad content higher than 90%, more preferably higher than 95%, even more preferably higher than 98%. The homopolymer of propylene contains regio defects (2,1-inserted units) between 0.01 and 1.5%, more preferably between 0.01 and 1.0%.

The polypropylene homopolymer may comprise or consist of a single polypropylene homopolymer fraction (=unimodal), but may also comprise a mixture of different polypropylene homopolymer fractions.

In cases where the polypropylene homopolymer comprises different fractions, the polypropylene homopolymer is understood to be bi- or multimodal. These fractions may have different average molecular weight or different molecular weight distribution.

It is preferred that the polypropylene homopolymer can be bimodal or multimodal with respect to molecular weight or molecular weight distribution.

It is alternatively preferred that the polypropylene homopolymer can be unimodal with respect to average molecular weight and/or molecular weight distribution.

Thus in one embodiment or the present invention the polypropylene matrix phase (A) is unimodal, whereas in another embodiment the polypropylene matrix phase (A) is bimodal and consists of two propylene homopolymer fractions (hPP-1) and (hPP-2).

In another embodiment, the polypropylene matrix phase (A) may be a random propylene copolymer, such as a propylene-ethylene random copolymer or propylene-butene random copolymer or a propylene-ethylene butene random copolymer or a combination thereof.

When an ethylene comonomer is present in the polypropylene matrix phase (insoluble fraction) component, its content can be up to 5 mol %, or 3.4 wt %, relative to the polypropylene matrix phase as a whole, while when butene comonomer is present, then its content can be up to 5 mol %, or 6.6 wt %, relative to the polypropylene matrix phase as a whole, provided that their combined content is at most 5 mol % relative to the polypropylene matrix phase as a whole. Even more preferably there is less than 2 wt % ethylene in the polypropylene matrix phase, relative to the total weight of the polypropylene matrix phase. It is therefore preferred if the ethylene content of the insoluble fraction of the polymers of the invention is 2 wt % or less, ideally 1.5 wt % or less, relative to the total weight of the polypropylene matrix phase (the total weight of the insoluble fraction). Even more preferably there is less than 1 wt % ethylene in the insoluble fraction (C2(IF)<1 wt %) relative to the total weight of the polypropylene matrix phase (the total weight of the insoluble fraction).

In a further embodiment, the polypropylene matrix phase (A) is bimodal and consists of one homopolymer fraction and one copolymer fraction.

It is preferred that the polypropylene matrix phase has a melting point (Tm) of 100 to 165° C., preferably 110 to 165° C., especially 120 to 165° C.

The MFR₂ of the polypropylene matrix phase (A) may be in the range of 0.1 to 200 g/10 min, such 1 to 150 g/10 min, preferably 2 to 100 g/10 min.

The intrinsic viscosity (iV) of the polypropylene matrix phase (A) is ideally 1 to 4 dl/g.

### Rubber Component (B)

The second component of the heterophasic polypropylene resin is the rubber component (B) i.e. the ethylene-propylene copolymer phase, which is an amorphous copolymer of propylene and ethylene. Thus, the second component is an amorphous copolymer, which is dispersed in the polypropylene matrix phase (A).

As stated above, the terms “soluble fraction”, “amorphous (propylene-ethylene) copolymer”, “dispersed phase” and “rubber phase” denote the same, i.e. are interchangeable in view of this invention.

The rubber phase which forms component (B) of the heterophasic polypropylene resin of the invention may be defined as above for the amorphous propylene-ethylene copolymer of the invention.

### Applications

The heterophasic polypropylene resins of the invention can be used in the manufacture of an article such as a flexible pipe/tube, profile, pad, cable insulation, sheet or film. These articles are useful in the medical and general packaging area but also for technical purposes like electrical power cables or geomembranes. Alternatively, the heterophasic polypropylene resin can be used in impact modification of a composition for injection moulding of articles, such as for technical applications in the automotive area.

For impact modification, the inventive heterophasic polypropylene resin may be blended with a further polymer. Thus, the invention also relates to polymer blends comprising the amorphous ethylene propylene copolymers or heterophasic polypropylene resins of the invention, in particular blends of either of these with other propylene polymers. The amorphous ethylene propylene copolymer of the invention may form 5 to 50 wt % of such a blend, such as 10 to 40 wt %, in particular 15 to 30 wt % of such a blend, relative to the total weight of the blend. Likewise, the heterophasic polypropylene resin of the invention may form 5 to 50 wt % of such a blend, such as 10 to 40 wt %, in particular 15 to 30 wt % of such a blend, relative to the total weight of the blend.

The heterophasic polypropylene resin might be mixed with a polypropylene having a higher MFR₂, such as at least 10 g/10 min. In particular, it can be mixed with polypropylenes used in car parts. Such polypropylenes may be homopolymers. Preferably they will not be other amorphous polymers like another EPR.

The polymers and resins of the invention are useful in the manufacture of a variety of end articles such as films (cast, blown or BOPP films), moulded articles (e.g. injection moulded, blow moulded, rotomoulded articles), extrusion coatings and so on. Preferably, articles comprising the films of the invention are used in packaging. Packaging of interest include heavy duty sacks, hygiene films, lamination films, and soft packaging films.

The invention will now be illustrated by reference to the following non-limiting examples.

### EXAMPLES

### Measurement Methods

### Al, B and Zr Determination (ICP-method)

In a glovebox, an aliquot of the catalyst (ca. 40 mg) was weighed into glass weighting boat using analytical balance. The sample was then allowed to be exposed to air overnight while being placed in a steel secondary container equipped with an air intake. Then 5 mL of concentrated (65%) nitric acid was used to rinse the content of the boat into the Xpress microwave oven vessel (20 mL). A sample was then subjected to a microwave-assisted digestion using MARS 6 laboratory microwave unit over 35 minutes at 150° C. The digested sample was allowed to cool down for at least 4 h and then was transferred into a glass volumetric glass flask of 100 mL volume. Standard solutions containing 1000 mg/L Y and Rh (0.4 mL) were added. The flask was then filled up with distilled water and shaken well. The solution was filtered through 0.45 μm Nylon syringe filters and then subjected to analysis using Thermo iCAP 6300 ICP-OES and iTEVA software.

The instrument was calibrated for Al, B, Hf, Mg, Ti and Zr using a blank (a solution of 5% HNO₃) and six standards of 0.005 mg/L, 0.01 mg/L, 0.1 mg/L, 1 mg/L, 10 mg/L and 100 mg/L of Al, B, Hf, Mg, Ti and Zr in solutions of 5% HNO₃ distilled water. However, not every calibration point was used for each wavelength. Each calibration solution contained 4 mg/L of Y and Rh standards. Al 394.401 nm was calibrated using the following calibration points: blank, 0.1 mg/L, 1 mg/L, 10 mg/L and 100 mg/L. Al 167.079 nm was calibrated as Al 394.401 nm excluding 100 mg/L and Zr 339.198 nm using the standards of blank, 0.01 mg/L, 0.1 mg/L, 1 mg/L, 10 mg/L and 100 mg/L. Curvilinear fitting and 1/concentration weighting was used for the calibration curves.

Immediately before analysis the calibration was verified and adjusted (instrument reslope function) using the blank and a 10 mg/L Al, B, Hf, Mg, Ti and Zr standard which had 4 mg/L Y and Rh. A quality control sample (QC: 1 mg/L Al, Au, Be, Hg & Se; 2 mg/L Hf & Zr, 2.5 mg/L As, B, Cd, Co, Cr, Mo, Ni, P, Sb, Sn & V; 4 mg/L Rh & Y; 5 mg/L Ca, K, Mg, Mn, Na & Ti; 10 mg/L Cu, Pb and Zn; 25 mg/L Fe and 37.5 mg/L Ca in a solution of 5% HNO3 in distilled water) was run to confirm the reslope for Al, B, Hf, Mg, Ti and Zr. The QC sample was also run at the end of a scheduled analysis set.

The content for Zr was monitored using Zr 339.198 nm {99} line. The content of aluminium was monitored via the 167.079 nm {502} line, when Al concentration in test portion was under 2 wt % and via the 394.401 nm {85} line for Al concentrations above 2 wt %. Y 371.030 nm {91} was used as internal standard for Zr 339.198 nm and Al 394.401 nm and Y 224.306 nm {450} for Al 167.079 nm. The content for B was monitored using B 249 nm line.

The reported values were back calculated to the original catalyst sample using the original mass of the catalyst aliquot and the dilution volume

### DSC Analysis

The melting point (Tₘ) and crystallization temperature (T_{c}) were determined on a DSC200 TA instrument, by placing a 5-7 mg polymer sample, into a closed DSC aluminium pan, heating the sample from −10° C. to 210° C. at 10° C./min, holding for 5 min at 210° C., cooling from 210° C. to −10° C., holding for 5 min at −10° C., heating from −10° C. to 210° C. at 10° C./min. The reported Tₘ is the maximum of the curve from the second heating scan and T_{c} is the maximum of the curve of the cooling scan.

### Melt Flow Rate

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR is determined at 230° C. at the loading of 2.16 kg (MFR2).

### Quantification of Microstructure by NMR Spectroscopy

Quantitative nuclear-magnetic resonance (NMR) spectroscopy was used to quantify the ethylene content and the isotacticity of the copolymers.

Quantitative ¹³C{¹H} NMR spectra were recorded in the solution-state using a Bruker Avance III 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent as described in G. Singh, A. Kothari, V. Gupta, Polymer Testing 2009, 28(5), 475.

To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme as described in Z. Zhou, R. Kuemmerle, X. Qiu, D. Redwine, R. Cong, A. Taha, D. Baugh, B. Winniford, J. Mag. Reson. 187 (2007) 225 and V. Busico, P. Carbonniere, R. Cipullo, C. Pellecchia, J. Severn, G. Talarico, Macromol. Rapid Commun. 2007, 28, 1128. A total of 6144 (6 k) transients were acquired per spectra.

Quantitative ¹³C{¹H} NMR spectra were processed, integrated and relevant quantitative properties determined from the integrals. All chemical shifts were indirectly referenced to the central methylene group of the ethylene block (EEE) at 30.00 ppm using the chemical shift of the solvent. This approach allowed comparable referencing even when this structural unit was not present.

With characteristic signals corresponding to 2,1 erythro regiodefects observed (as described in L. Resconi, L. Cavallo, A. Fait, F. Piemontesi, Chem. Rev. 2000, 100 (4), 1253, in Cheng, H. N., Macromolecules 1984, 17, 1950, and in W-J. Wang and S. Zhu, Macromolecules 2000, 33, 1157) the correction for the influence of the regiodefects on determined properties was required. Characteristic signals corresponding to other types of regiodefects were not observed.

Characteristic signals corresponding to the incorporation of ethylene were observed (as described in Cheng, H. N., Macromolecules 1984, 17, 1950) and the comonomer fraction calculated as the fraction of ethylene in the polymer with respect to all monomer in the polymer:

fE=(E/(P+E)

The comonomer fraction was quantified using the method of W-J. Wang and S. Zhu, Macromolecules 2000, 33, 1157, through integration of multiple signals across the whole spectral region in the ¹³C{¹H} spectra. This method was chosen for its robust nature and ability to account for the presence of regio-defects when needed. Integral regions were slightly adjusted to increase applicability across the whole range of encountered comonomer contents.

The mole percent comonomer incorporation was calculated from the mole fraction:

E[mol %]=100*fE

The weight percent comonomer incorporation was calculated from the mole fraction:

E[wt %]=100*(fE*28.06)/((fE*28.06)+((1−fE)*42.08))

The isotacticity of the copolymer was determined according to known methods, for example as described in Macromolecules 2005, vol. 38, pp. 3054-3059.

The isotacticity of the homopolymeric matrix was determined according to the following method:

Quantitative ¹³C{¹H} NMR spectra recorded in the solution-state using a Bruker Avance III 400 NMR spectrometer operating at 400.15 and 100.62 MHz for ¹H and ¹³C respectively. All spectra were recorded using a ¹³C optimised 10 mm selective excitation probehead at 125° C. using nitrogen gas for all pneumatics. Approximately 200 mg of material was dissolved in 1,2-tetrachloroethane-d₂ (TCE-d₂). This setup was chosen primarily for the high resolution needed for tacticity distribution quantification (Busico, V., Cipullo, R., Prog. Polym. Sci. 26 (2001) 443; Busico, V.; Cipullo, R., Monaco, G., Vacatello, M., Segre, A.L., Macromolecules 30 (1997) 6251). Standard single-pulse excitation was employed utilising the NOE and bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 11289). A total of 8192 (8k) transients were acquired per spectra. Quantitative ¹³C{¹H} NMR spectra were processed, integrated and relevant quantitative properties determined from the integrals using proprietary computer programs. All chemical shifts are internally referenced to the methyl signal of the isotactic pentad mmmm at 21.85 ppm.

The tacticity distribution was quantified through integration of the methyl region between 23.6 and 19.7 ppm correcting for any sites not related to the stereo sequences of interest (Busico, V., Cipullo, R., Prog. Polym. Sci. 26 (2001) 443; Busico, V., Cipullo, R., Monaco, G., Vacatello, M., Segre, A.L., Macromolecules 30 (1997) 6251). The pentad isotacticity was determined through direct integration of the methyl region and reported as either the mole fraction or percentage of isotactic pentad mmmm with respect to all steric pentads i.e. [mmmm]=mmmm/sum of all steric pentads. When appropriate integrals were corrected for the presence of sites not directly associated with steric pentads.

Characteristic signals corresponding to regio irregular propene insertion were observed (Resconi, L., Cavallo, L., Fait, A., Piemontesi, F., Chem. Rev. 2000, 100, 1253). The presence of secondary inserted propene in the form of 2,1 erythro regio defects was indicated by the presence of the two methyl signals at 17.7 and 17.2 ppm and confirmed by the presence of other characteristic signals. The amount of 2,1 erythro regio defects was quantified using the average integral (e) of the e6 and e8 sites observed at 17.7 and 17.2 ppm respectively, i.e. e=0.5*(e6+e8). Characteristic signals corresponding to other types of regio irregularity were not observed. The amount of primary inserted propene (p) was quantified based on the integral of all signals in the methyl region (CH3) from 23.6 to 19.7 ppm paying attention to correct for other species included in the integral not related to primary insertion and for primary insertion signals excluded from this region such that p=CH3+2*e. The relative content of a specific type of regio defect was reported as the mole fraction or percentage of said regio defect with respect all observed forms of propene insertion i.e. sum of all primary (1,2), secondary (2,1) and tertiary (3,1) inserted propene units, e.g. [21e]=e/(p+e+t+i). The total amount of secondary inserted propene in the form of 2,1-erythro or 2,1-threo regio defects was quantified as sum of all said regio irregular units, i.e. [21]=[21e]+[21t].

### Determination of Xylene Soluble Fraction (XS)

The xylene soluble fraction (XS) as defined and described in the present invention is determined in line with ISO 16152 as follows: 2.5±0.1 g of the polymer were dissolved in 250 ml o-xylene under reflux conditions and continuous stirring, under nitrogen atmosphere. After 30 minutes, the solution was allowed to cool, first for 15 minutes at ambient temperature and then maintained for 30 minutes under controlled conditions at 25±0.5° C. The solution was filtered through filter paper. For determination of the xylene soluble content, an aliquot (100 ml) of the filtrate was taken. This aliquot was evaporated in nitrogen flow and the residue dried under vacuum at 100° C. until constant weight is reached.

The xylene soluble fraction (weight percent) can then be determined as follows:

XS %=(100×m1×v0)/(m0×v1),

wherein m0 designates the initial polymer amount (grams), m1 defines the weight of residue (grams), v0 defines the initial volume (millilitre) and v1 defines the volume of the analysed sample (millilitre).

To obtain the amorphous copolymer fraction for further characterisation with GPC and NMR, the remaining xylene soluble filtrate was precipitated with acetone. The precipitated polymer was filtered and dried in the vacuum oven at 100° C. to constant weight.

### Intrinsic Viscosity

Intrinsic viscosity (iV) is measured according to DIN ISO 1628/1 (2009) and /3 (2010) (in Decalin at 135° C.). The intrinsic viscosity (iV) value increases with the molecular weight of a polymer.

### Crystex Method

The crystalline (CF) and soluble fractions (SF) of the heterophasic propylene resins as well as the comonomer content and intrinsic viscosities of the respective fractions were analyzed by the Crystex method. The crystalline and amorphous fractions are separated through temperature cycles of dissolution at 160° C., crystallization at 40° C. and re-dissolution in 1,2,4-trichlorobenzene (1,2,4-TCB) at 160° C. Quantification of SF and CF and determination of ethylene content (C2) are achieved by means of an infrared detector (IR4) and an online 2-capillary viscometer is used for determination of the intrinsic viscosity (iV).

IR4 detector is multiple wavelength detector detecting IR absorbance at two different bands (CH3 and CH2) for the determination of the concentration determination and the Ethylene content in Ethylene-Propylene copolymers. IR4 detector is calibrated with series of EP copolymers with known Ethylene content in the range of 2 wt.-% to 69 wt.-% (determined by 13C-NMR).

Amount of Soluble fraction (SF) and Crystalline Fraction (CF) are correlated through the XS calibration to the “Xylene Soluble” (XS) quantity and respectively Xylene Insoluble (XI) fractions, determined according to standard gravimetric method as per ISO16152 (2005). XS calibration is achieved by testing various EP copolymers with XS content in the range 2-31 wt %.

Intrinsic viscosity (iV) of the parent EP copolymer and its soluble and crystalline fractions are determined with a use of an online 2-capillary viscometer and are correlated to corresponding iV determined in decalin according to ISO 1628-3 (2010).

Calibration is achieved with several commercial EP PP copolymers with iV=2 to 4 dL/g.

A sample of the PP composition to be analyzed is weighed out in concentrations of 10 mg/ml to 20 mg/ml. After automated filling of the vial with 1,2,4-TCB containing 250 mg/I 2,6-tert-butyl-4-methylphenol (BHT) as antioxidant, the sample is dissolved at 160° C. until complete dissolution is achieved, usually for 60 min, with constant stirring of 800 rpm.

A defined volume of the sample solution is injected into the column filled with inert support where the crystallization of the sample and separation of the soluble fraction from the crystalline part is taking place. This process is repeated two times. During the first injection the whole sample is measured at high temperature, determining the iV[dl/g] and the C2[wt %] of the PP composition. During the second injection the soluble fraction (at low temperature) and the crystalline fraction (at high temperature) with the crystallization cycle are determined (Wt % SF, Wt % C2, iV).

### GPC Analysis

A high temperature GPC equipped with a suitable concentration detector (like IR5 or IR4 from PolymerChar (Valencia, Spain), an online four capillary bridge viscometer (PL-BV 400-HT), and a dual light scattering detector (PL-LS 15/90 light scattering detector) with a 15° and 90° angle was used. 3× Olexis and 1× Olexis Guard columns from Agilent as stationary phase and 1,2,4-trichlorobenzene (TCB, stabilized with 250 mg/L 2,6-Di tert butyl-4-methyl-phenol) as mobile phase at 160° C. and at a constant flow rate of 1 mL/min was applied. 200 μL of sample solution were injected per analysis. All samples were prepared by dissolving 8.0-10.0 mg of polymer in 10 mL (at 160° C.) of stabilized TCB (same as mobile phase) for 2,5 hours at 160° C. under continuous gentle shaking. The injected concentration of the polymer solution at 160° C. (c_{160° C.}) was determined in the following way.

$${c}_{160 ° C .} = \frac{{w}_{25}}{{V}_{25}} * 0.8772$$

With: w₂₅ (polymer weight) and V₂₅ (Volume of TCB at 25° C.).

GPC conventional: Molecular weight averages, molecular weight distribution, and polydispersity index (Mₙ, M_{w}, M_{w}/Mₙ)

### GPC

For GPC conventional (GPC_{conv}) the column set was calibrated using universal calibration (according to ISO 16014-2:2019) with 19 narrow MWD polystyrene (PS) standards in the range of 0.5 kg/mol to 11 500 kg/mol. The PS standards were dissolved at 160° C. for 15 min or alternatively at room temperatures at a concentration of 0.2 mg/ml for molecular weight higher and equal 899 kg/mol and at a concentration of 1 mg/ml for molecular weight below 899 kg/mol. The conversion of the polystyrene peak molecular weight to polyethylene molecular weights is accomplished by using the Mark Houwink equation and the following Mark Houwink constants:

K_{PS}=19×10⁻⁵ ml/g, α_{PS}=0.655

K_{PP}=39×10⁻⁵ ml/g, α_{PE}=0.725

K_{PE}=19×10⁻⁵ ml/g, α_{PE}=0.725

A third order polynomial fit was used to fit the calibration data.

All samples were prepared in the concentration range of 0.5 -1 mg/ml and dissolved at 160 ° C. for 3 hours under continuous gentle shaking

Molecular weight averages (Mz, Mw and Mn), Molecular weight distribution (MWD) and its broadness, described by polydispersity index, PD=Mw/Mn (wherein Mn is the number average molecular weight and Mw is the weight average molecular weight) were determined using the following formulas:

$${M}_{n} = \frac{{Σ}_{i = 1}^{N} {A}_{i}}{Σ ( {A}_{i} / {M}_{i} )} \qquad ( 1 )$$

$${M}_{w} = \frac{{Σ}_{i = 1}^{N} ( {A}_{i} \times {M}_{i} )}{Σ {A}_{i}} \qquad ( 2 )$$

$${M}_{z} = \frac{{Σ}_{i = 1}^{N} ( {A}_{i} \times {M}_{i}^{2} )}{Σ ( {A}_{i} / {M}_{i} )} \qquad ( 3 )$$

$${M}_{v} = {( \frac{{Σ}_{i = 1}^{N} ( {A}_{i} \times {M}_{i}^{α + 1} )}{Σ {A}_{i}} )}^{\frac{1}{α}} \qquad ( 4 )$$

For the molecular weight averages Mz, Mw and Mn the polyolefin molecular weight (MW) was determined by GPC_{conv}, where Mz(LS), Mw(LS) and Mn(LS) stands that this molecular weight averages were obtained by GPC_{LS}.

### GPC-VISC-LS Processing

For the GPC light scattering approach (GPC_{LS}), the inter detector delay volumes were determined with a narrow PS standard (MWD=1.01) with a molar mass of 130000 g/mol. The corresponding detector constants for the light scattering detector and the online viscometer were determined with the broad standard NIST1475A (Mw=52000 g/mol and iV=1.01 dl/g). The corresponding used dn/dc for the used PE standard in TCB was 0.094 cm³/g. The calculation was performed using the Cirrus Multi-Offline SEC-Software, Version 3.2 (Agilent).

The molar mass at each elution slice was calculated by using the 15° light scattering angle. Data collection, data processing and calculation were performed using the Cirrus Multi SEC-Software Version 3.2. As dn/dc used for the determination of molecular weight a value of 0.094 was used.

The molecular weight at each slice is calculated in the manner as it is described by C. Jackson and H. G. Barth at low angle. To correlate the elution volume to the molecular weight for calculating MWD and the corresponded molecular weight averages a linear fit was applied using the molecular weight data at each slice and the corresponded retention volume.

Molecular weight averages (Mz(LS), Mw(LS) and Mn(LS)), Molecular weight distribution (MWD) and its broadness, described by polydispersity, PD(LS)=Mw(LS)/Mn(LS) (wherein Mn(LS) is the number average molecular weight and Mw(LS) is the weight average molecular weight obtained from GPC-LS) were calculated by Gel Permeation Chromatography (GPC) using the following formulas:

$${M}_{n} ( L S ) = \frac{{Σ}_{i = 1}^{N} {A}_{i}}{Σ ( {A}_{i} / {M}_{i ( L S )} )} \qquad ( 1 )$$

$${M}_{w} ( L S ) = \frac{{Σ}_{i = 1}^{N} ( {A}_{i} \times {M}_{i ( L S )} )}{Σ {A}_{i}} \qquad ( 2 )$$

$${M}_{z} ( L S ) = \frac{{Σ}_{i = 1}^{N} ( {A}_{i} \times {M}_{i ( L S )}^{2} )}{Σ ( {A}_{i} / {M}_{i} ( L S ) )} \qquad ( 3 )$$

For a constant elution volume interval ΔVᵢ, where Aᵢ and M_{i(LS)} are the chromatographic peak slice area and polyolefin molecular weight (MW) determined by GPC-LS.

Branching Calculation g′(85-100% Cum)

The relative amount of branching is determined using the g′-index of the branched polymer sample. The long chain branching (LCB) index is defined as g′=[η]_{br}/[η]ₗᵢₙ. It is well known that if the g′ value increases the branching content decreases. [η] is the intrinsic viscosity (iV) at 160° C. in TCB of the polymer sample at a certain molecular weight and is measured by an online viscometer and a concentration detector, where [η]ₗᵢₙ is the intrinsic viscosity (iV) of the linear polymer having the same chemical composition. The intrinsic viscosities were measured as described in the handbook of the Cirrus Multi-Offline SEC-Software Version 3.2, with use of the Solomon-Gatesman equation. The [η]ₗᵢₙ at a certain molecular weight was obtained using the equation 1 with the corresponding Mark Houwink constant:

[η]lin =K_{EPC}*M^{α} (equation 1)

The constants K and α are specific for a polymer-solvent system and M is the molecular weight obtained from LS analysis.

To account for the amount of propylene in the EP Copolymer the [K]_{EPC} needs to be modified in the following way:

K_{EPC}=(1−⅓*mol.-%*(propylene))^{1+α*}K_{PE} (equation 2)

Where K_{PE}=0.00039 and α=0.725 and the propylene content is determined by ¹³C-NMR.

[η]ₗᵢₙ is the intrinsic viscosity (iV) of a linear sample and [η]_{br} the viscosity of a branched sample of the same molecular weight and chemical composition. By dividing the intrinsic viscosity of a branched sample [η]_{br} with the intrinsic viscosity (iV) of a linear polymer [η]ₗᵢₙ at the same molecular weight, the viscosity branching factor g′ can be calculated.

In this case the g′₍₈₅₋₁₀₀₎ is calculated by adding the product of g′_{M}*a_{M} in the range where the cumulative fraction is 85-100% and dividing it through the corresponded signal area of the concentration signal, aᵢ.

$${g}_{( 85 - 100 )}^{′} = \frac{{Σ}_{85}^{100} {a}_{i} * \frac{{[ η ]}_{br , i}}{{[ η ]}_{lin , i}}}{{Σ}_{85}^{100} {a}_{i}} = \frac{{Σ}_{85}^{100} {a}_{i} * {g}_{i}^{′}}{{Σ}_{85}^{100} {a}_{i}}$$

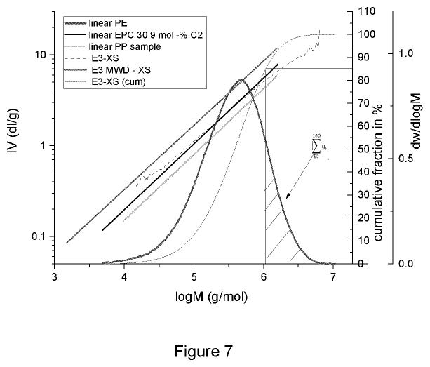

The calculation of the linear reference line as well as the calculation of the g′₍₈₅₋₁₀₀₎ is illustrated in FIG. 7.

The number of LCB/1000TC of the high molecular weight fraction (85-100 wt % of cumulative weight fraction) is calculated using the formula 1000*M₀*B/M_{z}*N_{c}, where B is the number of LCB per chain, M₀ is the molecular weight of the repeating unit, i.e. the propylene group, —CH₂—CH(CH₃)— (42), for PP, M_{z} is the z-average molecular weight and N_{c} is the number of C-Atoms in the monomer repeating unit (3 for polypropylene). The reported LCB/1000TC and the LCB per chain values in this application always stands for number of LCB/1000TC or LCB per chain of the high molecular weight fraction (85-100 wt % of cumulative weight fraction).

B is calculated using the Zimm-Stockmayer approach according to the following equation:

$$g = \frac{6}{B} \{ \frac{1}{2} {( \frac{2 + B}{B} )}^{1 / 2} ln [ \frac{{( 2 + B )}^{1 / 2} + {( B )}^{1 / 2}}{{( 2 + B )}^{1 / 2} - {( B )}^{1 / 2}} ] - 1 \}$$

where LCB is assumed to be tri-functional (or Y-shaped) and polydispersed and g is the branching index, defined as g=Rg(br)/Rg(lin) , where Rg is the radius of gyration (Y. Yu, E. Schwerdtfeger, M. McDaniel, Polymer Chemistry, 2012, 50, 1166-1179).

The branching index g can be obtained from the viscosity branching index g′ using the following correlation:

g=g′^{ϵ}

Where in this case ε=1.33

### Catalyst

### Synthesis

The ligands and metallocenes required to form the catalysts of the invention can be synthesised by any process and the skilled organic chemist would be able to devise various synthetic protocols for the manufacture of the necessary ligand materials. WO2007/116034 discloses the necessary chemistry. Synthetic protocols can also generally be found in WO2002/02576, WO2011/135004, WO2012/084961, WO2012/001052, WO2011/076780, WO2015/158790, WO2018/122134 and WO 2019/179959, wherein the protocol in WO 2019/179959 is most relevant for the present invention.

### Preparation of MAO-Silica Support

A steel reactor equipped with a mechanical stirrer and a filter net was flushed with nitrogen and the reactor temperature was set to 20° C. Next silica grade DM-L-303 from AGC Si-Tech Co, pre-calcined at 600° C. (5.0 kg) was added from a feeding drum followed by careful pressurizing and depressurizing with nitrogen using manual valves. Then toluene (22 kg) was added. The mixture was stirred for 15 min. Next 30 wt % solution of MAO in toluene (9.0 kg) from Lanxess was added via feed line on the top of the reactor within 70 min. The reaction mixture was then heated up to 90° C. and stirred at 90° C. for additional two hours. The slurry was allowed to settle and the mother liquor was filtered off. The catalyst was washed twice with toluene (22 kg) at 90° C., following by settling and filtration.

The reactor was cooled down to 60° C. and the solid was washed with heptane (22.2 kg). Finally, this solid was dried at 60° C. under nitrogen flow for 2 hours and then for 5 hours under vacuum (−0.5 barg) with stirring. The resulting SiO2/MAO carrier was collected as a free-flowing white powder containing 12.2% Al by weight.

Catalyst Preparation (Cat1)

30 wt % MAO in toluene (0.7 kg) was added into a steel nitrogen blanked reactor via a burette at 20° C. Toluene (5.4 kg) was then added under stirring. Metallocene rac-anti-dimethylsilanediyl[2-methyl-4,8-bis(3′,5′-dimethyl phenyl)-1,5,6,7-tetrahydro-s-indacen-1-yl][2-methyl-4-(3′,5′-dimethylphenyl)-5-methoxy-6-tert-butylinden-1-yl]zirconium dichloride (93 g) was added from a metal cylinder followed by flushing with 1 kg toluene. The mixture was stirred for 60 minutes at 20° C. Trityl tetrakis(pentafluorophenyl)borate (91 g) was then added from a metal cylinder followed by a flush with 1 kg of toluene. The mixture was stirred for 1 h at room temperature. The resulting solution was added to a stirred cake of MAO-silica support prepared as described above over 1 hour. The cake was allowed to stay for 12 hours, followed by drying under N2 flow at 60° C. for 2 h and additionally for 5 h under vacuum (−0.5 barg) under stirring. Dried catalyst was obtained in the form of pink, free-flowing powder containing 13.6% Al and 0.105% Zr by ICP analysis.

### Catalyst Preparation (Cat2, Cat3)

Cat2 and Cat3 have been prepared as described for Cat1, adjusting the metallocene and trityl tetrakis(pentafluorophenyl)borate amounts in order to obtain the composition reported in Table 1.

The composition of the catalysts employed in the Examples is summarized in Error! Reference source not found.

TABLE 1
Catalyst composition (from ICP).

| | Al | Zr | B | Al/Zr | MC in catalyst |
|---|---|---|---|---|---|
| Catalyst | wt % | wt % | wt % | molar | wt % |
| Cat1 | 13.6 | 0.105 | 0.0123 | 440 | 1.05 |
| Cat2 | 14.7 | 0.073 | 0.0087 | 680 | 0.73 |
| Cat3 | 15.4 | 0.066 | 0.0080 | 790 | 0.66 |

### Polymerisations:

### Step 1: Prepolymerisation and Bulk Homopolymerisation

The autoclave containing 0.4 bar-g propylene was filled with 3950 g propylene. Triethylaluminium (0.80 ml of a 0.62 mol/l solution in heptane) was injected into the reactor by additional 240 g propylene. The solution was stirred at 20° C. and 250 rpm for at least 20 min. The catalyst was injected as described in the following. The desired amount of solid catalyst was loaded into a 5 ml stainless steel vial inside a glovebox, then a second 5 ml vial containing 4 ml n-heptane and pressurized with 7 bars of nitrogen was added on top of it. This dual feeder system was mounted on a port on the lid of the autoclave. Directly follows the dosing of the desired H2 amount via massflow controller. Afterwards the valve between the two vials was opened and the solid catalyst was contacted with heptane under nitrogen pressure for 2 s, and then flushed into the reactor with 240 g propylene. The prepolymerisation was run for 10 min. At the end of the prepolymerisation step, the temperature was raised to 75° C. and was held constant throughout the polymerisation. The polymerisation time was measured starting, when the internal reactor temperature reached 2° C. below the set polymerisation temperature.

### Step 2: Gas Phase C3C2 Copolymerisation

After the bulk step was completed, the stirrer speed was reduced to 50 rpm and the pressure was reduced to 0.3 bar-g by venting the monomer. Then triethylaluminium (0.80 ml of a 0.62 mol/l solution in heptane) was injected into the reactor by additional 250 g propylene through a steel vial. The pressure was then again reduced down to 0.4 bar-g by venting the monomer. The stirrer speed was set to 180 rpm and the reactor temperature was set to the target temperature. Then the target reactor pressure was reached by feeding a C3/C2 gas mixture (see polymerisation table) of composition defined by:

$${( \frac{{C}_{2}}{{C}_{3}} )}_{gas feed in transition} = \frac{{( \frac{{C}_{2}}{{C}_{3}} )}_{target polymer composition}}{R}$$

where C2/C3 is the weight ratio of the two monomers and R is the reactivity ratio determined independently or assumed based on similar experiments.

The temperature is kept constant by thermostat and the pressure is kept constant by feeding via mass flow controller, a C3/C2 gas mixture of composition corresponding to the target polymer composition and by thermostat, until the set time for this step has expired.

Then the reactor was cooled down (to about 30° C.) and the volatile components flashed out. After purging the reactor 3 times with N2 and one vacuum/N2 cycle, the product was taken out and dried overnight in a fume hood. 100 g of the polymer was additivated with 0.5 wt % Irganox B225 (solution in acetone) and dried overnight in a hood followed by 2 hours in a vacuum drying oven at 60° C.

### Polymers

Three sets of heterophasic copolymers were produced under the above conditions with the catalysts Cat1, Cat2 and Cat3, setting the rubber composition at ˜25 wt % and the gas phase reactor temperature at 70° C., using gas phase polymerisation pressures in the range 20 to 35 bar-g.

Similar experiments have been carried out setting the rubber composition at ˜25 wt % and the gas phase reactor temperature at 90° C. with catalysts Cat1 and Cat3.

Additional experiments have been performed setting the rubber composition at 70 wt % and 80 wt % with Cat2.

The results are listed in Tables 2 to 5.

TABLE 2
Polymerisation conditions 1/2 (bulk step propylene
homopolymerisation at 75° C., 40 min)

| | | | | | | | Transition | | | | |
|---|---|---|---|---|---|---|---|---|---|---|---|
| | | | | | | | | H2 | Bulk | | |
| | | Catalyst | | Prepoly | | | | dosing | total | Average | |
| | | | amount | T | time | H2 | H2 | rate | H2 | T | time |
| # | GP2 | — | mg | ° C. | min | NL | NL | NL/min | NL | ° C. | min |
| CE1 | C2 = 25 | Cat1 | 52 | 20 | 10 | 2.00 | 0.00 | 0.75 | 2.00 | 75 | 40 |
| IE1 | C2 = 25 | Cat1 | 65.0 | 20 | 10 | 2.01 | 0.00 | 1.5 | 2.01 | 75 | 40 |
| CE2 | C2 = 25 | Cat1 | 51.4 | 20 | 10 | 0.50 | 2.50 | 1.5 | 3.00 | 75 | 40 |
| IE2 | C2 = 25 | Cat1 | 59.5 | 20 | 10 | 0.50 | 2.50 | 1.5 | 3.00 | 75 | 40 |
| CE3 | C2 = 25 | Cat2 | 62.0 | 20 | 10 | 0.10 | 1.90 | 1.5 | 2.00 | 75 | 40 |
| CE4 | C2 = 25 | Cat2 | 58.0 | 20 | 10 | 0.10 | 1.90 | 1.5 | 2.00 | 75 | 40 |
| IE3 | C2 = 25 | Cat2 | 59.0 | 20 | 10 | 0.10 | 1.90 | 1.5 | 2.00 | 75 | 40 |
| IE4 | C2 = 25 | Cat2 | 61.0 | 20 | 10 | 0.10 | 1.90 | 1.5 | 2.00 | 75 | 40 |
| CE5 | C2 = 70 | Cat2 | 62.0 | 20 | 10 | 0.10 | 1.90 | 1.5 | 2.00 | 75 | 40 |
| IE5 | C2 = 70 | Cat2 | 53 | 20 | 10 | 0.10 | 1.92 | 1.5 | 2.02 | 75 | 40 |
| CE6 | C2 = 80 | Cat2 | 84 | 20 | 10 | 0.10 | 1.91 | 1.5 | 2.01 | 75 | 40 |
| IE6 | C2 = 80 | Cat2 | 60.0 | 20 | 10 | 0.10 | 1.90 | 1.5 | 2.00 | 75 | 40 |
| CE7 | C2 = 25 | Cat3 | 62.0 | 25 | 10 | 0.50 | 2.50 | 1.5 | 3.00 | 75 | 40 |
| CE8 | C2 = 25 | Cat3 | 60.0 | 25 | 10 | 0.50 | 2.50 | 1.5 | 3.00 | 75 | 40 |
| CE9 | C2 = 25 | Cat3 | 77.0 | 25 | 10 | 0.50 | 2.50 | 1.5 | 3.00 | 75 | 40 |
| IE7 | C2 = 25 | Cat3 | 68.0 | 25 | 10 | 0.50 | 2.50 | 1.5 | 3.00 | 75 | 40 |
| IE8 | C2 = 25 | Cat3 | 69.0 | 25 | 10 | 0.50 | 2.50 | 1.5 | 3.00 | 75 | 40 |
| CE10 | C2 = 25 | Cat3 | 71.0 | 25 | 10 | 0.50 | 2.50 | 1.5 | 3.00 | 75 | 40 |
| CE11 | C2 = 25 | Cat3 | 76.0 | 25 | 10 | 0.50 | 2.50 | 1.5 | 3.00 | 75 | 40 |
| CE12 | C2 = 25 | Cat3 | 75.0 | 25 | 10 | 0.50 | 2.50 | 1.5 | 3.00 | 75 | 40 |
| IE9 | C2 = 25 | Cat3 | 76.0 | 25 | 10 | 0.50 | 2.50 | 1.5 | 3.00 | 75 | 40 |

TABLE 3
Polymerisation conditions 2/2 (Gas Phase)

| | Gas Phase | | | | | | | | | |
|---|---|---|---|---|---|---|---|---|---|---|
| | Time | | | | | | | | | |
| | transition | C2 fed in | C3 fed in | feed C2/C3 | | | | C2 fed | C3 fed | |
| | from bulk | transition | transition | during | P · | | | in GP | in GP | feed |
| | to GP | (MFC) | (MFC) | transition | average | T | t | (MFC) | (MFC) | C2/C3 |
| # | min | g | g | wt/wt | barg | ° C. | min | g | g | wt/wt |
| CE1 | 23 | 238 | 346 | 0.69 | 20 | 70 | 90 | 43 | 128 | 0.34 |
| IE1 | 20 | 485 | 712 | 0.68 | 35 | 70 | 90 | 297 | 904 | 0.33 |
| CE2 | 17 | 218 | 323 | 0.6749 | 20 | 90 | 90 | 50 | 153 | 0.33 |
| IE2 | 17 | 374 | 712 | 0.5253 | 35 | 90 | 90 | 196 | 596 | 0.33 |
| CE3 | 14 | 190 | 198 | 0.9596 | 15 | 70 | 123 | 58 | 179 | 0.32 |
| CE4 | 17 | 315 | 424 | 0.7429 | 25 | 70 | 47 | 53 | 163 | 0.33 |
| IE3 | 18 | 382 | 568 | 0.6725 | 30 | 70 | 30 | 59 | 179 | 0.33 |
| IE4 | 20 | 460 | 751 | 0.6125 | 35 | 70 | 22 | 49 | 148 | 0.33 |
| CE5 | 16 | 346 | 75 | 4.6133 | 20 | 90 | 111 | 163 | 73 | 2.23 |
| IE5 | 28 | 1037 | 316 | 3.2759 | 50 | 90 | 90 | 518 | 223 | 2.32 |
| CE6 | 17 | 358 | 44.5 | 8.0449 | 20 | 90 | 125 | 246 | 57 | 4.30 |
| IE6 | 26 | 697 | 96 | 7.2604 | 35 | 90 | 50 | 177 | 50 | 3.54 |
| CE7 | 15 | 251 | 314 | 0.7994 | 20 | 70 | 101 | 58 | 180 | 0.32 |
| CE8 | 16 | 181 | 220 | 0.8227 | 15 | 70 | 200 | 55 | 169 | 0.33 |
| CE9 | 17 | 317 | 427 | 0.7424 | 25 | 70 | 75 | 73 | 224 | 0.33 |
| IE7 | 18 | 385 | 571 | 0.6743 | 30 | 70 | 50 | 59 | 183 | 0.32 |
| IE8 | 21 | 460 | 755 | 0.6093 | 35 | 70 | 35 | 72 | 220 | 0.33 |
| CE10 | 22 | 165 | 244 | 0.6762 | 15 | 90 | 184 | 70 | 216 | 0.32 |
| CE11 | 20 | 218 | 356 | 0.6124 | 20 | 90 | 114 | 68 | 210 | 0.32 |
| CE12 | 23 | 277 | 475 | 0.5832 | 25 | 90 | 59 | 76 | 231 | 0.33 |
| IE9 | 22 | 335 | 588 | 0.5697 | 30 | 90 | 35 | 70 | 212 | 0.33 |

TABLE 4
Polymer characterisation 1/2

| | Results | | | | | | | | |
|---|---|---|---|---|---|---|---|---|---|
| | | productivity | activity | | | | | | |
| | | in GP | in GP | | | Analytical results whole material | | | |
| | Total | calculated | calculated | split | MFR₂ | SF | iV | | |
| | yield | from SF | from SF | bulk | powder | Crystex | Crystex | Tm | Hm |
| # | g | kgPP/g_{MC} | kgPP/g_{cat}/h | % | g/10 min | wt % | dl/g | ° C. | J/g |
| CE1 | 1097 | 326 | 218 | 84 | 2.2 | 16.2 | 2.5 | 155 | 83 |
| IE1 | 2812 | 1821 | 1214 | 56 | 0.5 | 44.2 | 3.4 | | |
| CE2 | 730 | 365 | 244 | 73 | 11.0 | 27.0 | 2.0 | | |
| IE2 | 1324 | 1235 | 823 | 42 | 2.0 | 58.3 | 3.1 | 156 | 47 |
| CE3 | 984 | 483 | 235 | 78 | 7.20 | 22.2 | 2.0 | 154 | 79 |
| CE4 | 806 | 503 | 642 | 74 | 6.70 | 26.4 | 2.2 | 154 | 74 |
| IE3 | 933 | 574 | 1148 | 74 | 6.40 | 26.5 | 2.3 | 154 | 68 |
| IE4 | 798 | 523 | 1427 | 71 | 5.50 | 29.2 | 2.5 | 153 | 69 |
| CE5 | 845 | 450 | 243 | 76 | 5.3 | 24.1 | 2.4 | 154 | 73 |
| IE5 | 1063 | 1838 | 1225 | 33 | 0.1 | 66.9 | 5.9 | | |
| CE6 | 1120 | 416 | 200 | 77 | 5.4 | 22.8 | 2.5 | | |
| IE6 | 1004 | 535 | 643 | 77 | 3.4 | 23.4 | 3.0 | | |
| CE7 | 910 | 623 | 370 | 72 | 14.1 | 28.0 | 2.2 | 153.7 | 78 |
| CE8 | 808 | 465 | 140 | 77 | 19.8 | 22.8 | 1.9 | | |
| CE9 | 1060 | 499 | 399 | 76 | 14.0 | 23.9 | 2.1 | | |
| IE7 | 934 | 514 | 617 | 75 | 16.2 | 24.7 | 2.1 | | |
| IE8 | 1197 | 642 | 1100 | 76 | 12.0 | 24.4 | 2.3 | | |
| CE10 | 1123 | 510 | 166 | 79 | 18.5 | 21.3 | 1.7 | | |
| CE11 | 970 | 398 | 210 | 79 | 18.6 | 20.6 | 1.8 | | |
| CE12 | 1233 | 600 | 610 | 76 | 15.6 | 24.1 | 1.9 | | |
| IE9 | 1093 | 579 | 992 | 73 | 15.0 | 26.6 | 2.0 | | |

TABLE 5
Polymer characterisation 2/2

| | Analytical results soluble fraction | | | | | | Insoluble fraction | |
|---|---|---|---|---|---|---|---|---|
| | iV (SF) | | | C2 | C2 | | IV (IF) | MFR(IF) |
| | (Crystex) | Mw | | (NMR) | (NMR) | R | (Crystex) | calc. from |
| # | dl/g | g/mol | Mw/Mn | wt % | mol % | NMR | dL/g | IV(IF) |
| CE1 | 3.8 | 459000 | 3.0 | 23.60 | 31.66 | 0.45 | 2.2 | 3.3 |
| IE1 | 4.8 | 603500 | 3.1 | 25.85 | 34.34 | 0.51 | 2.3 | 2.7 |
| CE2 | 3.6 | 516000 | 3.1 | 25.67 | 34.13 | 0.51 | 1.4 | 28.5 |
| IE2 | 4.2 | 647000 | 3.3 | 26.22 | 34.77 | 0.68 | 1.4 | 27.5 |
| CE3 | 3.1 | | | 26.75 | 35.39 | 0.38 | 1.7 | 13.0 |
| CE4 | 3.9 | | | 26.24 | 34.79 | 0.48 | 1.6 | 15.2 |
| IE3 | 4.3 | | | 24.72 | 33.00 | 0.49 | 1.6 | 14.7 |
| IE4 | 4.3 | | | 24.07 | 32.23 | 0.52 | 1.7 | 12.7 |
| CE5 | 4.5 | 351695 | 3.4 | 69.77 | 77.59 | 0.50 | 1.7 | 11.6 |
| IE5 | 7.1 | 826500 | 2.7 | 74.64 | 81.53 | 0.90 | 2.7 | 1.2 |
| CE6 | 5.2 | | | 76.73 | 83.2 | 0.41 | 1.7 | 11.2 |
| IE6 | 6.6 | | | 80.54 | 86.1 | 0.57 | 1.8 | 8.9 |
| CE7 | 3.9 | 470000 | 2.9 | 25.37 | 33.77 | 0.43 | 1.4 | 27.5 |
| CE8 | 3.6 | | | 24.08 | 32.2 | 0.39 | 1.4 | 31.7 |
| CE9 | 4.2 | | | 25.27 | 33.7 | 0.46 | 1.4 | 30.5 |
| IE7 | 4.5 | | | 24.51 | 32.8 | 0.48 | 1.4 | 34.0 |
| IE8 | 4.8 | | | 23.75 | 31.8 | 0.51 | 1.5 | 25.6 |
| CE10 | 3.0 | | | 25.69 | 34.2 | 0.51 | 1.4 | 32.8 |
| CE11 | 3.3 | | | 25.69 | 34.2 | 0.56 | 1.4 | 34.0 |
| CE12 | 3.6 | | | 26.01 | 34.5 | 0.60 | 1.4 | 32.8 |
| IE9 | 3.7 | | | 26.45 | 35.0 | 0.63 | 1.4 | 34.0 |

### Rubber Molecular Weight Dependence on GPR Pressure

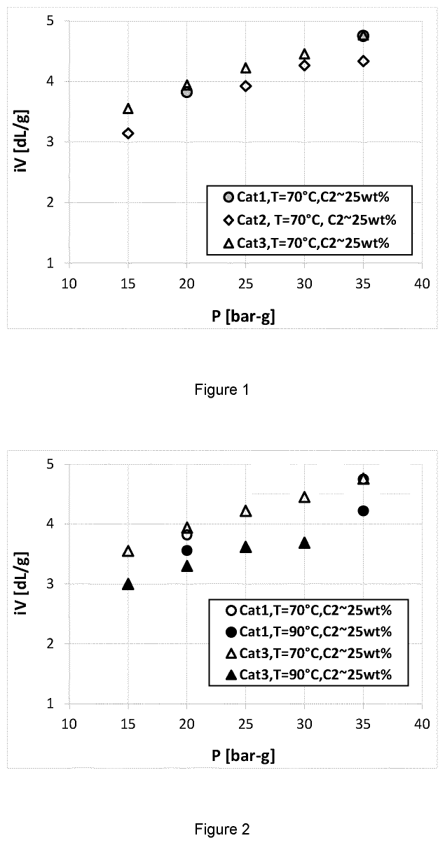

The increase of intrinsic viscosity with pressure at 70° C. and C2 at about 25 wt % is shown in FIG. 1 for the three catalysts.

The increase of intrinsic viscosity with pressure at two temperatures and C2 at about 25 wt % is shown in FIG. 2 for catalysts Cat1 and Cat3.

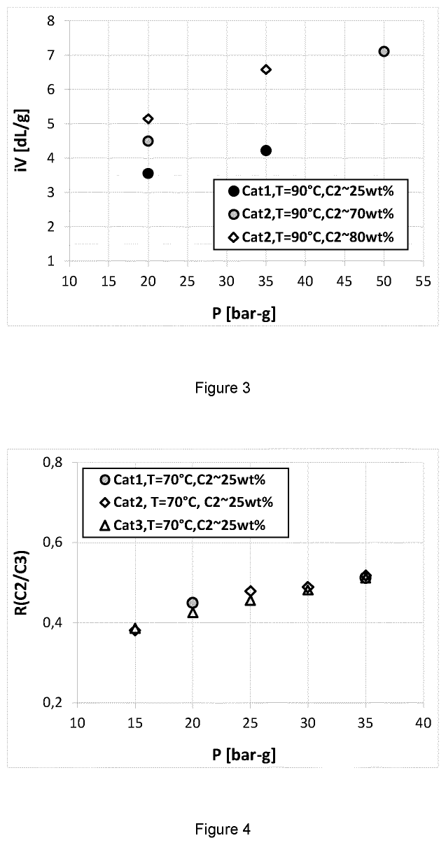

The increase of intrinsic viscosity with pressure at 90° C. and three levels of C2 content is shown in FIG. 3 for catalysts Cat1 and Cat2.

### C2/C3 Reactivity Ratio and Polymer Composition Dependence on GPR Pressure

The increase of the ethylene/propylene relative reactivity ratio with pressure at 70° C. and C2˜25 wt % is shown in FIG. 4 for the three catalysts.

The increase of the ethylene/propylene relative reactivity ratio with pressure at two temperatures and C2˜25 wt % is shown in FIG. 5 for catalysts Cat1 and Cat3.

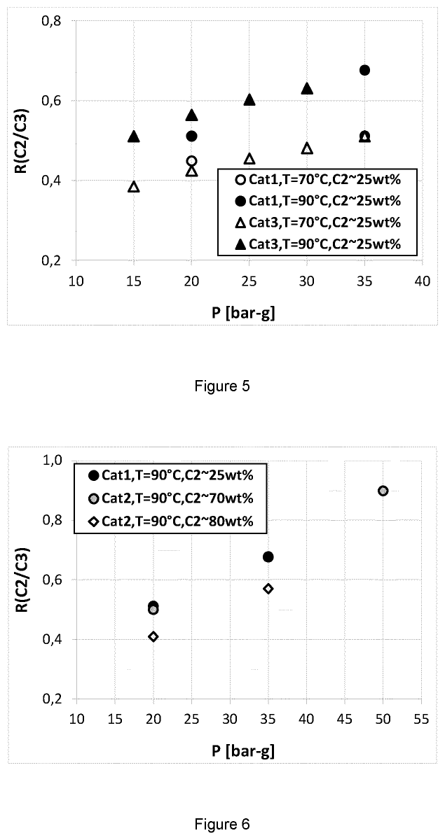

The increase of the ethylene/propylene relative reactivity ratio with pressure at 90° C. and three levels of C2 content is shown in FIG. 6 for catalysts Cat1 and Cat2.

The rubber phase (Soluble fraction) of the present heterophasic copolymers contain LCB as shown in Table 6.

TABLE 6
LCB

| | | | | | g′(85-100) | | |
|---|---|---|---|---|---|---|---|
| | | | iV | C2 | (GPC- | | |
| | T_{GP} | P | (SF) | (NMR) | VISC- | LCB | LCB |
| sample | ° C. | Bar-g | dL/g | mol % | LS) | #/chain | #/1000TC |
| IE2-XS | 90 | 35 | 4.2 | 34.8 | 0.69 | 9.0 | 0.092 |
| R1-20- | | | | | | | |
| 033-XS | | | | | | | |

1. A process for the preparation of a heterophasic polypropylene resin in a multistage polymerisation process in the presence of a metallocene catalyst, said process comprising:
(I) in a first polymerisation step, polymerising propylene and optionally at least one C2-10 alpha olefin comonomer to a obtain polypropylene matrix phase (A); and subsequently
(II) in a second polymerisation step, polymerising propylene, ethylene and optionally at least one C3-10 alpha olefin comonomer, in the presence of the metallocene catalyst and polymer from step (I) to obtain an ethylene-propylene copolymer phase (B) dispersed in the matrix phase (A);
wherein said metallocene catalyst comprises a metallocene complex of Formula I 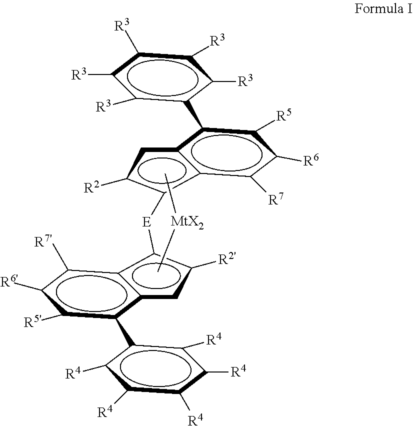
wherein Mt is Zr or Hf;
each X is a sigma-ligand;
E is a —CR¹₂—, —CR¹₂—CR¹₂—, —CR¹₂—SiR¹₂—, —SiR¹₂— or —SiR¹₂—SiR¹₂— group chemically linking the two cyclopentadienyl ligands; The R¹ groups, which can be the same or can be different, are hydrogen or C₁₋₂₀ hydrocarbyl groups, optionally containing up to 2 silicon, oxygen, sulphur or nitrogen atoms, and optionally two R¹ groups can be part of a C₄-C₈ ring,
R² and R^{2′} are the same or different from each other;
R² is a —CH₂R group, with R being H or a linear or branched C₁₋₆ alkyl group, C₃₋₈ cycloalkyl group, C₆₋₁₀ aryl group;
R^{2′} is a C₁₋₂₀ hydrocarbyl group; preferably, R² and R^{2′} are the same and are linear or branched C₁₋₆ alkyl groups;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY group wherein Y is a C₁₋₁₀ hydrocarbyl group, and optionally two adjacent R³ or R⁴ groups can be part of a ring including the phenyl carbons to which they are bonded;
each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY group wherein Y is a C₁₋₁₀ hydrocarbyl group, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;
R⁷ and R^{7′}, same or different from each other, are H or an OY group or a C₁₋₂₀ hydrocarbyl group optionally containing up to two silicon, oxygen, sulphur or nitrogen atoms, with the proviso that when R⁷═H, then both R⁵, R⁶≠H, and when R^{7′}═H, then both R^{5′},R^{6′}≠H, and with the additional proviso that R⁵ and R⁶ can be hydrogen only when R⁷ is different from hydrogen and that R^{5′} and R^{6′} can be hydrogen only when R^{7′} is different from hydrogen; and
wherein step (II) takes place in at least one gas phase reactor operating at a pressure of at least 26 bar.

2. A process as claimed in claim 1, wherein said at least one gas phase reactor of step (II) is operated at a reactor pressure of at least at least 28 bar, preferably at least 30 bar, more preferably at least 35 bar, typically in the range of 26 to 60 bar, preferably in the range of 28 to 50, more preferably in the range of 30 to 45 bar, even more preferably in the range of 30 to 38 bar.

3. A process as claimed in claim 1 or 2, wherein the ethylene-propylene copolymer phase (B) is an amorphous ethylene-propylene copolymer with an intrinsic viscosity (iV) measured in decalin at 135° C. of at least 3.5 dl/g and an ethylene content of at least 15 wt % of the total weight to the ethylene-propylene copolymer, comprising at least 4, preferably 5, long chain branches (LCB) per copolymer chain measured as described in the Measurement methods section Branching Calculation g′(85-100 cum).

4. A process as claimed in any of claims 1 to 3, wherein said metallocene complex has a structure described by Formula II: 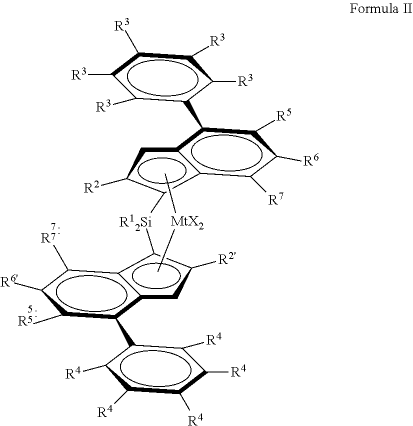
wherein Mt is Zr or Hf;
X, which can be the same or different from each other, are halogen, hydrogen, C₁₋₂₀ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;
the two R¹ groups on silicon, which can be the same or different from each other, are hydrogen or C₁₋₂₀ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;
R² and R^{2′} are the same or different from each other;
R² is a —CH₂ R group, with R being H or a linear or branched C₁₋₆ alkyl group, C₃₋₈ cycloalkyl group, C₆₋₁₀ aryl group optionally containing up to 2 silicon, oxygen, sulphur or nitrogen atoms;
R^{2′} is a C₁₋₂₀ hydrocarbyl group optionally containing up to 2 silicon, oxygen, sulphur or nitrogen atoms; preferably, R² and R^{2′} are the same and are linear or branched C₁₋₆ alkyl groups;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY or NY₂ group wherein Y is a C₁₋₁₀ hydrocarbyl group, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand; and
R⁷ and R^{7′}, same or different from each other, are H or an OY group or a C₁₋₂₀ hydrocarbyl group optionally containing up to two silicon, oxygen, sulphur or nitrogen atoms, with the proviso that when R⁷═H, then both R⁵, R⁶≠H, and when R^{7′}═H, then both R^{5′}, R^{6′}≠H, and with the additional proviso that R⁵ and R⁶ can be hydrogen only when R⁷ is different from hydrogen and that R^{5′} and R^{6′} can be hydrogen only when R^{7′} is different from hydrogen;
or Formula III 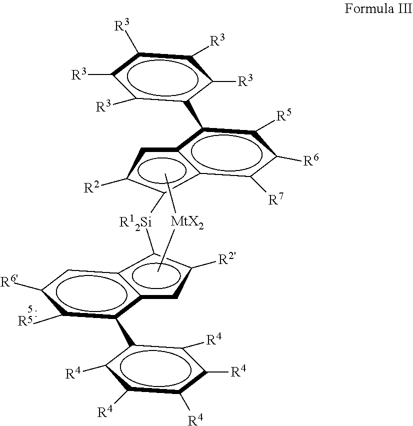
wherein Mt is Zr or Hf;
X, which can be the same or different from each other, are halogen, hydrogen, C₁₋₆ hydrocarbyl groups, or OY or NY₂ groups wherein Y is a C₁₋₆ hydrocarbyl group optionally containing 1 silicon atom;
the two R¹ groups on silicon, which can be the same or different from each other, are hydrogen or C₁₋₈ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;
R² and R^{2′} are the same or different from each other, and are a —CH₂ R group, with R being H or a linear or branched C₁₋₆ alkyl group, C₃₋₈ cycloalkyl group, C₆₋₁₀ aryl group;
preferably, R² and R^{2′} are the same and are linear or branched C₁₋₆ alkyl groups;
each R³ and R⁴ are independently the same or can be different and are hydrogen, a linear or branched C₁₋C₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY group wherein Y is a C₁₋₁₀ hydrocarbyl group, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;
R⁷ is H or an OY group or a C₁₋₂₀ hydrocarbyl group optionally containing up to two silicon, oxygen, sulphur or nitrogen atoms, with the proviso that when R⁷═H, then both R⁵, R⁶≠H, and with the additional proviso that R⁵ and R⁶ can be hydrogen only when R⁷ is different from hydrogen.

5. A process as claimed in any of claims 1 to 4, wherein said metallocene complex has a structure described by Formula XIII: 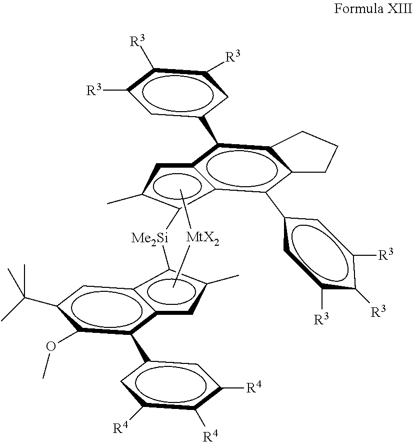
wherein M is Zr or Hf;
X, which can be the same or different from each other, are halogen, C₁₋₆ hydrocarbyl groups, or OY or NY₂ groups wherein Y is a C₁₋₁₀ hydrocarbyl group optionally containing up to 2 silicon atoms;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded.

6. A heterophasic polypropylene resin obtained or obtainable by a process as defined in any of claims 1 to 5.

7. A heterophasic polypropylene resin as claimed in claim 6, comprising a polypropylene matrix phase (A) and an ethylene-propylene copolymer phase (B) dispersed within said polypropylene matrix phase, wherein the ethylene-propylene copolymer phase (B) is an amorphous ethylene-propylene copolymer with an intrinsic viscosity (iV) measured in decalin at 135° C. of at least 3.5 dl/g and an ethylene content of at least 15 wt % of the total weight to the ethylene-propylene copolymer, comprising at least 4, preferably 5, long chain branches (LCB) per copolymer chain.

8. A heterophasic polypropylene resin comprising a polypropylene matrix phase (A) and an ethylene-propylene copolymer phase (B) dispersed within said polypropylene matrix phase, wherein the ethylene-propylene copolymer phase (B) is an amorphous ethylene-propylene copolymer with an intrinsic viscosity (iV) measured in decalin at 135° C. of at least 3.5 dl/g and an ethylene content of at least 15 wt % of the total weight to the ethylene-propylene copolymer, comprising at least 4, preferably 5, long chain branches (LCB) per copolymer chain.

9. A heterophasic polypropylene resin as claimed in any of claims 6 to 8, wherein the amorphous ethylene propylene copolymer has an Mw of at least 300,000 Da, preferably at least 350,000 Da, more preferably at least 400,000 Da.

10. A heterophasic polypropylene resin as claimed in any of claims 6 to 9, wherein the amorphous ethylene propylene copolymer has an iV measured in decalin at 135° C. of at least 4.0 dl/g, preferably at least 4.5 dl/g, more preferably 4.5 to 7.0 dl/g.

11. A heterophasic polypropylene resin as claimed in any one of claims 6 to 10, wherein whereby said LCB are constituted of ethylene and propylene and do not contain crystallisable propylene sequences.

12. A heterophasic polypropylene resin as claimed in any one of the claims 6 to 11, said resin comprising at least 40 wt %, preferably 45 to 90 wt %, more preferably 50 to 85 wt %, of said polypropylene matrix phase (A), relative to the total weight of the heterophasic polypropylene resin.

13. A heterophasic polypropylene resin as claimed in any one of claims 6 to 12, said resin comprising at least 10 wt %, preferably 10 to 55 wt %, more preferably 15 to 50 wt %, of said ethylene-propylene copolymer phase (B), relative to the total weight of the heterophasic polypropylene resin.

14. A heterophasic polypropylene resin as claimed in any of claims 6 to 13, wherein said resin has an MFR² (measured according to ISO1133 at 230° C. with 2.16 kg load) of 0.1 to 200 g/10 min, more preferably 1.0 to 100 g/10 min, such as 2.0 to 50 g/10 min.

15. Use of a heterophasic polypropylene resin as defined in any of claims 6 to 14 in the manufacture of an article, e.g. a flexible tube, pipe, profile, cable insulation, sheet, or film.
